(19) United States
(12) Patent Application Publication
(10) Pub. No.: US 2011/0007904 A1
(43) Pub. Date: Jan. 13, 2011

(54) ACOUSTIC SIGNAL PROCESSING DEVICE AND ACOUSTIC SIGNAL PROCESSING METHOD

(75) Inventors: Nobuhiro Tomoda, Tsurugashima City (JP); Keitaro Sugawara, Tokorozawa (JP); Kensaku Yoshida, Bunkyo (JP); Takaichi Sano, Shiki (JP); Momotoshi Furunobu, Kawagoe City (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/920,162

(22) PCT Filed: Feb. 29, 2008
(86) PCT No.: PCT/JP2008/053616

§ 371 Date: Aug. 30, 2010

(51) Int. Cl. H04R 5/00

(52) U.S. Cl. 381/17

(57) ABSTRACT

A corrective measurement part of a processing control part 119A measures an aspect of specific sound field correction processing performed on an acoustic signal received from a specific external device. Based on this measurement result, settings for cancellation of specific sound field correction processing performed on that acoustic signal are made for a correction cancellation part 310. Furthermore, an aspect of appropriate sound field processing corresponding to the actual sound field space is acquired by an appropriate correction acquisition part of the processing control part 119A. Based on the result acquired in this manner, settings for performing appropriate sound field correction processing upon a signal SND are made for a correction processing part 330. Thus, whichever one of acoustic signals received by a reception processing part 111 is selected, an output acoustic signal can be supplied to speaker units in after appropriate sound field correction processing.

### TECHNICAL FIELD

The present invention relates to an acoustic signal processing device, to an acoustic signal processing method, to an acoustic signal processing program, and to a recording medium upon which that acoustic signal processing program is recorded.

### BACKGROUND ART

In recent years, along with the widespread use of DVDs (Digital Versatile Disks) and so on, audio devices of the multi-channel surround sound type having a plurality of speakers have also become widespread. Due to this, it has become possible to enjoy surround sound brimming over with realism both in interior household spaces and in interior vehicle spaces.

There are various types of installation environment for audio devices of this type. Because of this, quite often circumstances occur in which it is not possible to arrange a plurality of speakers that output audio in positions which are symmetrical from the standpoint of the multi-channel surround sound format. In particular, if an audio device that employs the multi-channel surround sound format is to be installed in a vehicle, due to constraints upon the sitting positions which are also the listening positions, it is not possible to arrange a plurality of speakers in the symmetrical positions that are recommended from the standpoint of the multi-channel surround sound format. Furthermore, when the multi-channel surround sound format is implemented, it is often the case that the characteristics of the speakers are not optimal. Due to this, in order to obtain good quality surround sound by employing the multi-channel surround sound format, it becomes necessary to correct the sound field by correcting the acoustic signals.

Now, the audio devices (hereinafter termed “sound source devices”) for which acoustic signal correction of the kind described above for sound field correction and so on becomes necessary are not limited to being devices of a single type. For example, as sound source devices that are expected to be mounted in vehicles, there are players that replay the contents of audio of the type described above recorded upon a DVD or the like, broadcast reception devices that replay the contents of audio received upon broadcast waves, and so on. In these circumstances, a technique has been proposed for standardization of means for acoustic signal correction (refer to Patent Document #1, which is hereinafter referred to as the “prior art example”).

With the technique of this prior art example, along with acoustic signals being inputted from a plurality of sound source devices, audio that corresponds to that sound source device for which replay selection has been performed is replay outputted from the speakers. And, when the selection for replay is changed over, audio volume correction is performed by an audio volume correction means that is common to the plurality of sound source devices, in order to ensure that the audio volume level is appropriate.
Patent Document #1: Japanese Laid-Open Patent Publication 2006-99834.

### DISCLOSURE OF THE INVENTION

### Problems to be Solved by the Invention

The technique of the prior art example described above is a technique for suppressing the occurrence of a sense of discomfort in the user with respect to audio volume, due to changeover of the sound source device. Due to this, the technique of the prior art example is not one in which sound field correction processing is performed for making it appear that the sound field created by output audio from a plurality of speakers is brimming over with realism.

Now, for example, sound field correction processing that is specified in the original acoustic signal and that is faithful to its acoustic contents may be carried out within a sound source device which is mounted to a vehicle during manufacture of the vehicle (i.e. which is so called original equipment), so as to generate acoustic signals for supply to the speakers. On the other hand, in the case of an audio device that is not original equipment, generally the original acoustic signal is generated as the acoustic signal to be supplied to the speakers. Due to this, even if appropriate sound field correction processing is performed upon such an acoustic signal that is generated by a sound source device that is not original equipment; this is not necessarily the same as appropriate sound field processing upon the acoustic signal that is generated by a sound source device that is original equipment.

Because of this fact, a technique is desirable by which it would be possible to perform appropriate sound field correction processing, even if audio replay is performed with a sound source device in which sound field correction processing is carried out and a sound source device in which no sound field correction processing is carried out being changed over. To respond to this requirement is considered as being one of the problems that the present invention should solve.

The present invention has been conceived in the light of the circumstances described above, and its object is to provide an acoustic signal processing device and an acoustic signal processing method that are capable of supplying output acoustic signals to speakers in a state in which appropriate sound field correction processing has been carried out thereupon, whichever one of a plurality of acoustic signals is selected.

### Means for Solving the Problems

Considered from a first standpoint, the present invention is an acoustic signal processing device that creates acoustic signals to be supplied to a plurality of speakers that output sound to a sound field space, characterized by comprising: a reception means that receives acoustic signals from each of a plurality of external devices; a measurement means that measures an aspect of specific sound field correction processing, which is sound field correction processing carried out upon a specific acoustic signal, which is an acoustic signal received from a specific one among said plurality of external devices; an acquisition means that acquires an aspect of appropriate correction processing, which is sound field correction processing corresponding to said sound field space that is to be carried out upon an original acoustic signal; and a generation means that, when said specific acoustic signal has been selected as the acoustic signal to be supplied to said plurality of speakers, generates an acoustic signal by carrying out said appropriate correction processing upon the original acoustic signal that corresponds to said specific acoustic signal, on the basis of the result of measurement by said measurement means and the result of acquisition by said acquisition means.

Considered from a second standpoint, the present invention is an acoustic signal processing method that creates acoustic signals to be supplied to a plurality of speakers that output sound to a sound field space, characterized by including: a measurement process of measuring an aspect of specific sound field correction processing, which is sound field correction processing carried out upon a specific acoustic signal, which is an acoustic signal received from a specific one among a plurality of external devices; an acquisition process of acquiring an aspect of appropriate correction processing, which is sound field correction processing corresponding to said sound field space that is to be carried out upon an original acoustic signal; and a generation process of, when said specific acoustic signal has been selected as the acoustic signal to be supplied to said plurality of speakers, generating an acoustic signal by carrying out said appropriate correction processing upon the original acoustic signal that corresponds to said specific acoustic signal, on the basis of the result of measurement by said measurement process and the result of acquisition by said acquisition process.

Moreover, considered from a third standpoint, the present invention is an acoustic signal processing program, characterized in that it causes a calculation means to execute the acoustic signal processing method of the present invention.

Considered from a fourth standpoint, the present invention is a recording medium, characterized in that the acoustic signal processing program of the present invention is recorded thereupon in a manner that is readable by a calculation means.

### BRIEF DESCRIPTION OF THE DRAWINGS

FIG. 1 is a block diagram schematically showing the structure of an acoustic signal processing device according to the first embodiment of the present invention;

FIG. 2 is a figure for explanation of the positions in which four speaker units of FIG. 1 are arranged;

FIG. 3 is a block diagram for explanation of the structure of a control unit of FIG. 1;

FIG. 4 is a block diagram for explanation of the structure of a reception processing part of FIG. 1;

FIG. 5 is a block diagram for explanation of the structure of an output audio data generation part of FIG. 3;

FIG. 6 is a block diagram for explanation of the structure of a replay audio data generation part of FIG. 5;

FIG. 7 is a block diagram for explanation of the structure of a correction cancellation part of FIG. 6;

FIG. 8 is a block diagram for explanation of the structure of a correction processing part of FIG. 6;

FIG. 9 is a block diagram for explanation of the structure of a signal selection part of FIG. 5;

FIG. 10 is a block diagram for explanation of the structure of a processing control part of FIG. 3;

FIG. 11 is a figure for explanation of audio contents for measurement, used during synchronization correction processing measurement for specific sound field correction processing;

FIG. 12 is a figure for explanation of a measurement subject signal during synchronization correction processing measurement for specific sound field correction processing;

FIG. 13 is a flow chart for explanation of measurement processing for aspects of specific sound field correction processing and setting processing for correction cancellation by the device of FIG. 1;

FIG. 14 is a flow chart for explanation of acquisition processing for aspects of appropriate sound field correction processing and setting process for appropriate sound field correction by the device of FIG. 1;

FIG. 15 is a block diagram schematically showing the structure of an acoustic signal processing device according to the second embodiment of the present invention;

FIG. 16 is a block diagram for explanation of the structure of a control unit of FIG. 15;

FIG. 17 is a block diagram for explanation of the structure of a replay audio data generation part of an output audio data generation part of FIG. 16;

FIG. 18 is a block diagram for explanation of the structure of a processing control part of FIG. 16;

FIG. 19 is a figure for explanation of contents stored in a storage part of FIG. 18;

FIG. 20 is a flow chart for explanation of measurement processing for one aspect of specific sound field correction processing by the device of FIG. 15;

FIG. 21 is a flow chart for explanation of measurement processing for aspects of specific sound field correction processing by the device of FIG. 15;

FIG. 22 is a flow chart for explanation of processing corresponding to selection of replay audio by the device of FIG. 15;

FIG. 23 is a block diagram schematically showing the structure of an acoustic signal processing device according to the third embodiment of the present invention;

FIG. 24 is a block diagram for explanation of the structure of a control unit of FIG. 23;

FIG. 25 is a block diagram for explanation of the structure of a replay audio data generation part of an output audio data generation part of FIG. 24;

FIG. 26 is a block diagram for explanation of the structure of a processing control part of FIG. 23; and

FIG. 27 is a flow chart for explanation of processing corresponding to replay audio selection by the device of FIG. 23.

### BEST MODE FOR CARRYING OUT THE INVENTION

In the following, embodiments of the present invention will be explained with reference to the appended drawings. It should be understood that, in the following explanation and the drawings, to elements which are the same or equivalent, the same reference symbols are appended, and duplicated explanation is omitted.

### The First Embodiment

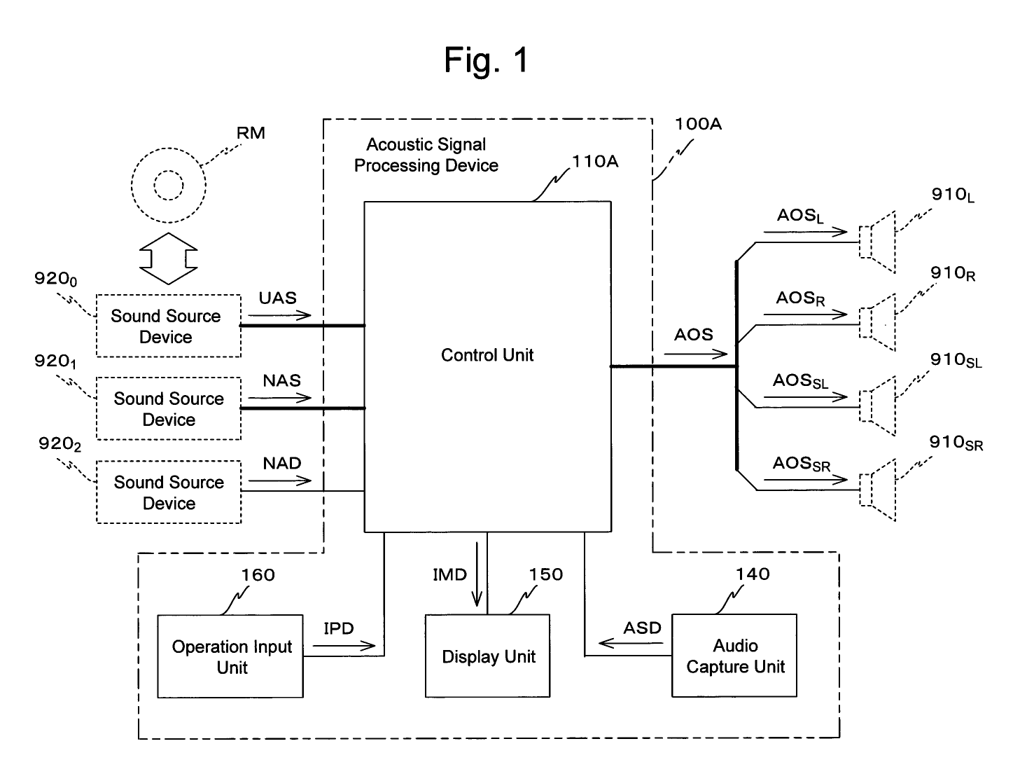

First, the first embodiment of the present invention will be explained with reference to FIGS. 1 through 14.

### <Structure>

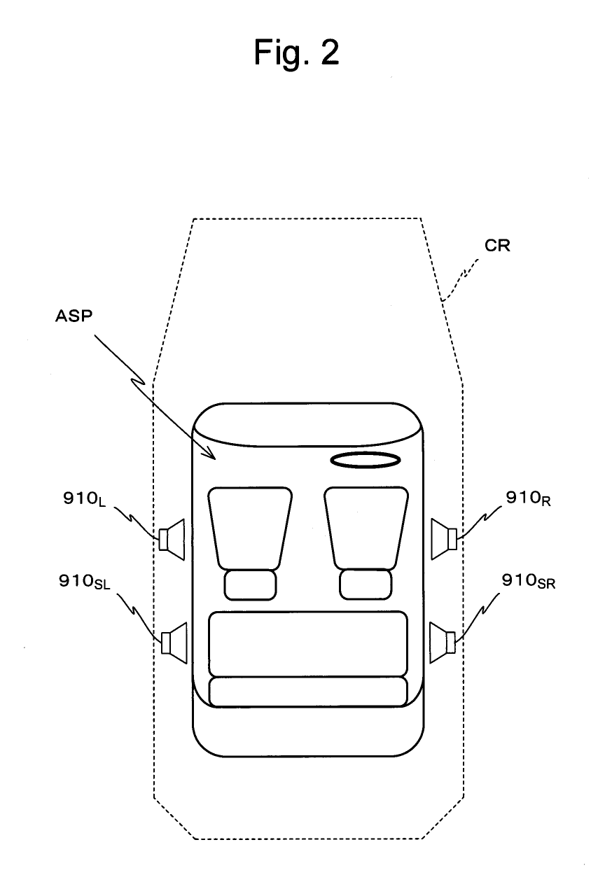

In FIG. 1, the schematic structure of an acoustic signal processing device 100A according to the first embodiment is shown as a block diagram. It should be understood that, in the following explanation, it will be supposed that this acoustic signal processing device 100A is a device that is mounted to a vehicle CR (refer to FIG. 2). Moreover, it will be supposed that this acoustic signal processing device 100A performs processing upon an acoustic signal of the four channel surround sound format, which is one multi-channel surround sound format. It will be supposed that by an acoustic signal of the four channel surround sound format, is meant an acoustic signal having a four channel structure and including a left channel (hereinafter termed the “L channel”), a right channel (hereinafter termed the “R channel”), a surround left channel (hereinafter termed the “SL channel”), and a surround right channel (hereinafter termed the “SR channel”).

As shown in FIG. 1, speaker units 910_{L} through 910_{SR} that correspond to the channels L through SR are connected to this acoustic signal processing device 100A. Each of these speaker units 910ⱼ (where j=L through SR) replays and outputs sound according to an individual output acoustic signal AOSⱼ in an output acoustic signal AOS that is dispatched from a control unit 110A.

In this embodiment, as shown in FIG. 2, the speaker unit 910_{L} is disposed within the frame of the front door on the passenger's seat side. This speaker unit 910_{L} is arranged so as to face the passenger's seat.

Moreover, the speaker unit 910_{R} is disposed within the frame of the front door on the driver's seat side. This speaker unit 910_{R} is arranged so as to face the driver's seat.

Furthermore, the speaker unit 910_{SL} is disposed within the portion of the vehicle frame behind the passenger's seat on that side. This speaker unit 910_{SL} is arranged so as to face the portion of the rear seat on the passenger's seat side.

Yet further, the speaker unit 910_{SR} is disposed within the portion of the vehicle frame behind the driver's seat on that side. This speaker unit 910_{SR} is arranged so as to face the portion of the rear seat on the driver's seat side.

With the arrangement as described above, audio is outputted into a sound field space ASP from the speaker units 910_{L} through 910_{SR}.

Returning to FIG. 1, sound source devices 920₀, 920₁, and 920₂ are connected to the acoustic signal processing device 100A. Here, it is arranged for each of the sound source devices 920₀, 920₁, and 920₂ to generate an acoustic signal on the basis of audio contents, and to send that signal to the acoustic signal processing device 100A.

The sound source device 920₀ described above generates an original acoustic signal of a four channel structure that is faithful to the audio contents recorded upon a recording medium RM such as a DVD or the like. Specific sound field correction processing is carried out upon that original acoustic signal by the sound source device 920₀, and an acoustic signal UAS is thereby generated.

It should be understood that, in the first embodiment, this acoustic signal UAS consists of four analog signals UAS_{L} through UAS_{SR}. Here, each of the analog signals UAS (where j=L through SR) is a signal in a format that can be supplied to the corresponding speaker unit 910ⱼ.

The sound source device 920₁ described above generates an original acoustic signal of a four channel structure that is faithful to some audio contents. This original acoustic signal from the sound source device 920₁ is sent to the acoustic signal processing device 100A as an acoustic signal NAS. It should be understood that, in this first embodiment, this acoustic signal NAS consists of four analog signals NAS_{L} through NAS_{SR}. Here, the analog signal NASⱼ (where j=L through SR) is a signal in a format that can be supplied to the corresponding speaker unit 910ⱼ.

The sound source device 920₂ described above then generates an original acoustic signal of a four channel structure that is faithful to audio contents. This original acoustic signal from the sound source device 920₂ is sent to the acoustic signal processing device 100A as an acoustic signal NAD. It should be understood that, in this first embodiment, the acoustic signal NAD is a digital signal in which signal separation for each of the four channels is not performed.

Next, the details of the above described acoustic signal processing device 100A according to this first embodiment will be explained. As shown in FIG. 1, this acoustic signal processing device 100A comprises a control unit 110A, an audio capture unit 140 that serves as an audio capture means, a display unit 150, and an operation input unit 160.

The control unit 110A performs processing for generation of the output acoustic signal AOS, on the basis of measurement processing of aspects of the appropriate sound field correction processing described above, and on the basis of the acoustic signal from one or another of the sound source devices 920₀ through 920₂. This control unit 110A will be described hereinafter.

The audio capture unit 140 described above comprises: (i) a microphone that gathers ambient sound and converts it into an analog electrical audio signal; (ii) an amplifier that amplifies this analog audio signal outputted from the microphone; and (iii) an A/D converter (Analog to Digital Converter) that converts the amplified analog audio signal into a digital audio signal. Here, the microphone is disposed in at least a single predetermined position in the sound field space ASP. The result of audio capture by the audio capture unit 140 of measurement audio outputted from the speaker units 910_{L} through 910_{SR} is reported to the control unit 110A as audio capture result data ASD.

The display unit 150 described above may comprise, for example: (i) a display device such as a liquid crystal panel, an organic EL (Electro Luminescent) panel, a PDP (Plasma Display Panel), or the like; (ii) a display controller such as a graphic renderer or the like, that performs overall control of the display unit 150; (iii) a display image memory that stores display image data; and so on. This display unit 150 displays operation guidance information and so on, according to display data IMD from the control unit 110A.

The operation input unit 160 described above is a key part that is provided to the main portion of the acoustic signal processing device 100A, and/or a remote input device that includes a key part, or the like. Here, a touch panel provided to the display device of the display unit 150 may be used as the key part that is provided to the main portion. It should be understood that, instead of a structure that includes a key part, or in parallel therewith, it would also be possible to employ a structure in which an audio recognition technique is employed and input is performed via voice.

Setting of the details of the operation of the acoustic signal processing device 100A is performed by the user operating this operation input unit 160. For example, the user may utilize the operation input unit 160 to issue: a command for measurement of aspects of the appropriate sound field correction processing; an audio selection command for selecting which of the sound source devices 920₀ through 920₂ should be taken as that sound source device from which audio based upon its acoustic signal should be outputted from the speaker units 910_{L} through 910_{SR}; and the like. The input details set in this manner are sent from the operation input unit 160 to the control unit 110A as operation input data IPD.

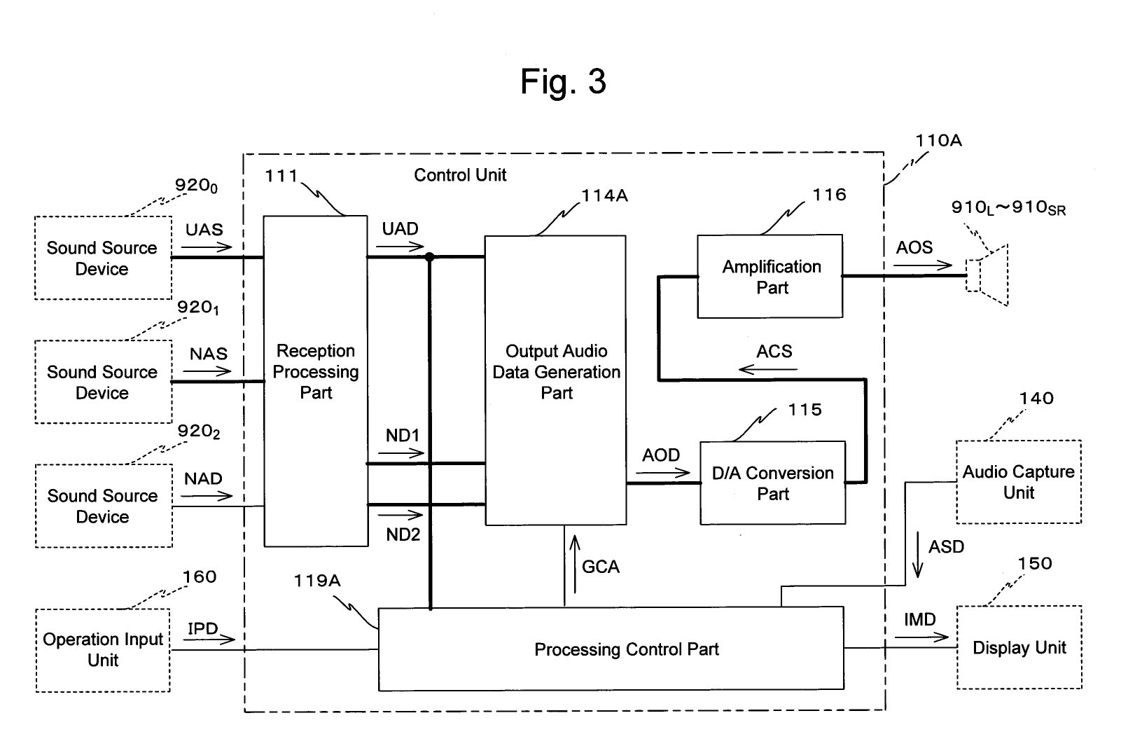

As shown in FIG. 3, the control unit 110A described above comprises a reception processing part 111 that serves as a reception means, and an output audio data generation part 114A. Furthermore, the control unit 110A also comprises a D/A (Digital to Analog) conversion part 115 and an amplification part 116. Yet further, the control unit 110A also comprises a processing control part 119A.

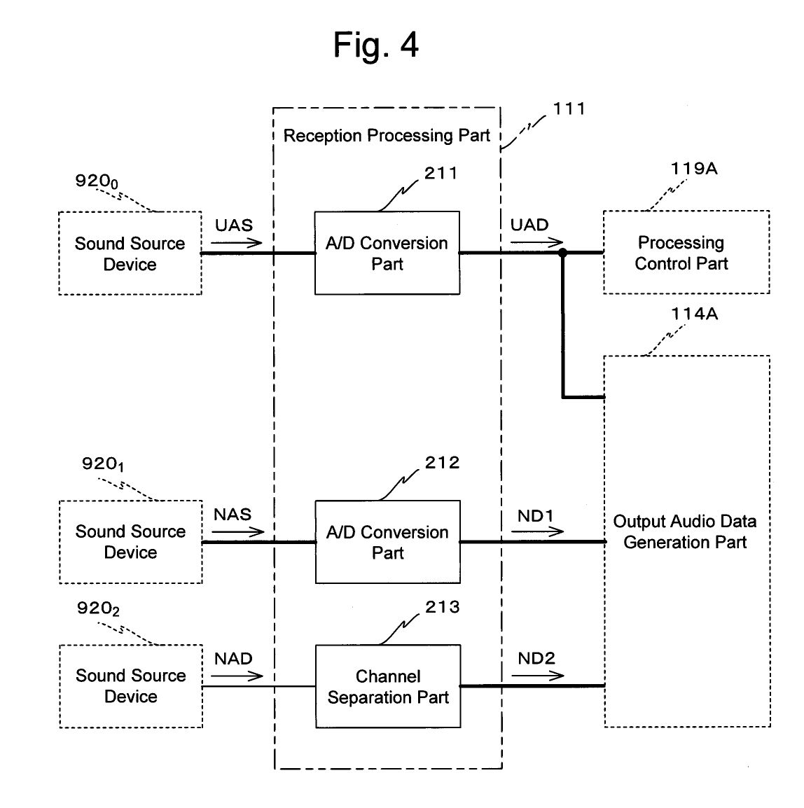

The reception processing part 111 described above receives the acoustic signal UAS from the sound source device 920₀, the acoustic signal NAS from the sound source device 920₁, and the acoustic signal NAD from the sound source device 920₂. And the reception processing part 111 generates a signal UAD from the acoustic signal UAS and generates a signal ND1 from the acoustic signal NAS, and also generates a signal ND2 from the acoustic signal NAD. As shown in FIG. 4, this reception processing part 111 comprises A/D (Analog to Digital) conversion parts 211 and 212 and a channel separation part 213.

The A/D conversion part 211 described above includes four A/D converters. This A/D conversion part 211 receives the acoustic signal UAS from the sound source device 920₀. The A/D conversion part 211 performs A/D conversion upon each of the individual acoustic signals UAS_{L} through UAS_{SR}, which are the analog signals included in the acoustic signal UAS, and generates a signal UAD in digital format. This signal UAD that has been generated in this manner is sent to the processing control part 119A and to the output audio data generation part 114A. It should be understood that individual signals UAD that result from A/D conversion of the individual acoustic signals UAS are included in this signal UAD.

Like the A/D conversion part 211, the A/D conversion part 212 described above includes four separate A/D converters. This A/D conversion part 212 receives the acoustic signal NAS from the sound source device 920₁. The A/D conversion part 212 performs A/D conversion upon each of the individual acoustic signals NAS_{L} through NAS_{SR}, which are the analog signals included in the acoustic signal NAS, and generates the signal ND1 which is in digital format. The signal ND1 that is generated in this manner is sent to the output audio data generation part 114A. It should be understood that individual signals ND1ⱼ resulting from A/D conversion of the individual acoustic signals NASⱼ (where j=L through SR) are included in the signal ND1.

The channel separation part 213 described above receives the acoustic signal NAD from the sound source device 920₂. This channel separation part 213 analyzes the acoustic signal NAD, and generates the signal ND2 by separating the acoustic signal NAD into individual signals ND2_{L} through ND2_{SR} that correspond to the L through SR channels of the four channel-surround sound format, according to the channel designation information included in the acoustic signal NAD. The signal ND2 that is generated in this manner is sent to the output audio data generation part 114A.

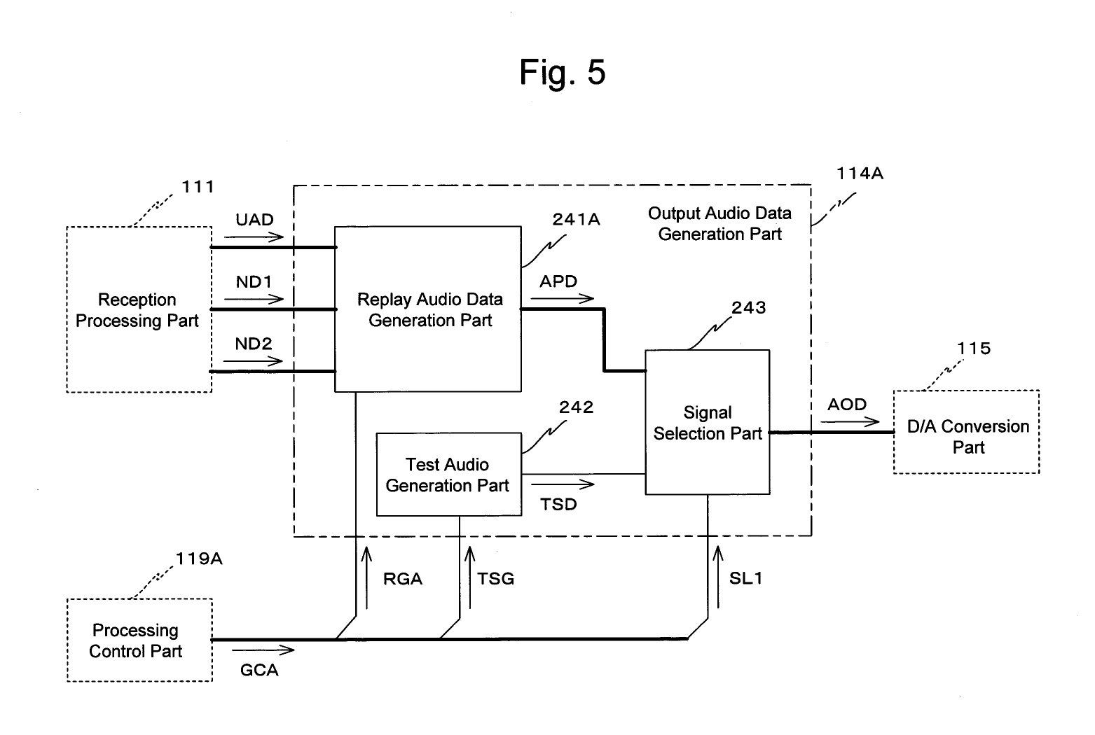

Returning to FIG. 3, the output audio data generation part 114A described above receives the signals UAD, ND1, and ND2 from the reception processing part 111. The output audio data generation part 114A generates a signal AOD according to a generation control command GCA from the processing control part 119A. Here, this signal AOD includes individual signals AOD_{L} through AOD_{SR} corresponding to the channels L through SR. As shown in FIG. 5, this output audio data generation part 114A comprises a replay audio data generation part 241A that serves as a generation means, a test audio generation part 242, and a signal selection part 243.

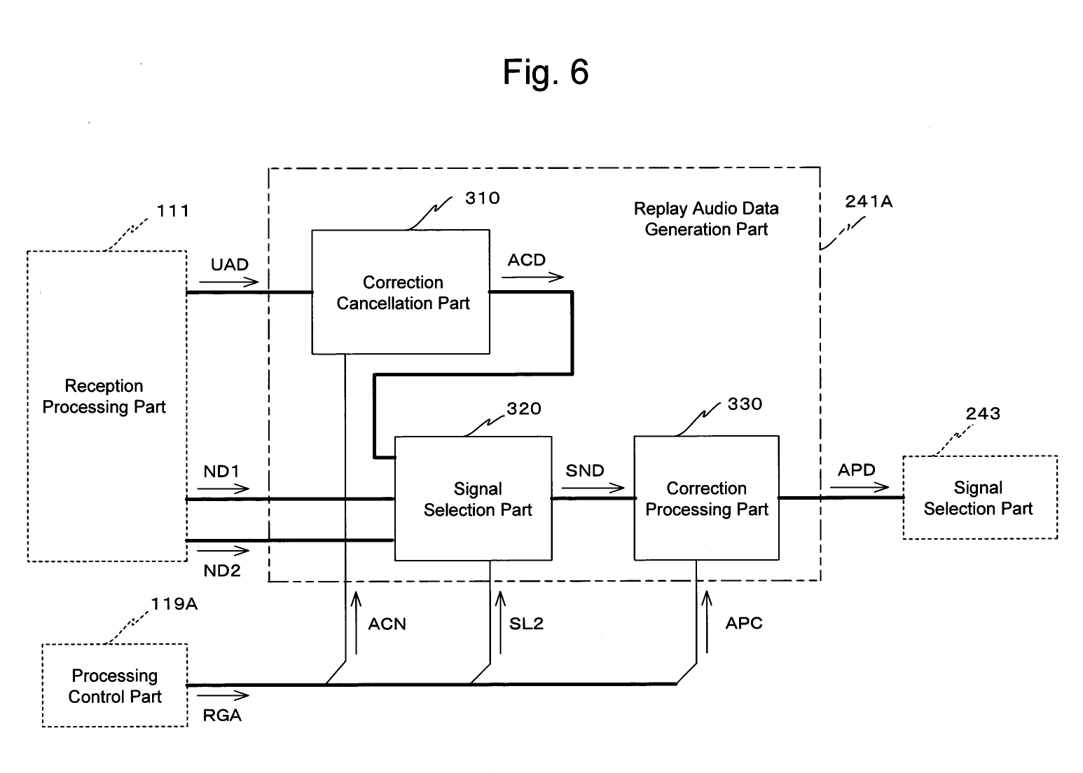

The replay audio data generation part 241A described above receives the signals UAD, ND1, and ND2 from the reception processing part 111. This replay audio data generation part 241A generates a signal APD according to a replay generation command RGA in the generation control command GCA. Here, individual signals APD_{L} through APD_{SR} that correspond to the channels L through SR are included in this signal APD. As shown in FIG. 6, this replay audio data generation part 241A comprises a correction cancellation part 310 that serves as a cancellation means, a signal selection part 320, and a correction processing part 330 that serves as a correction means.

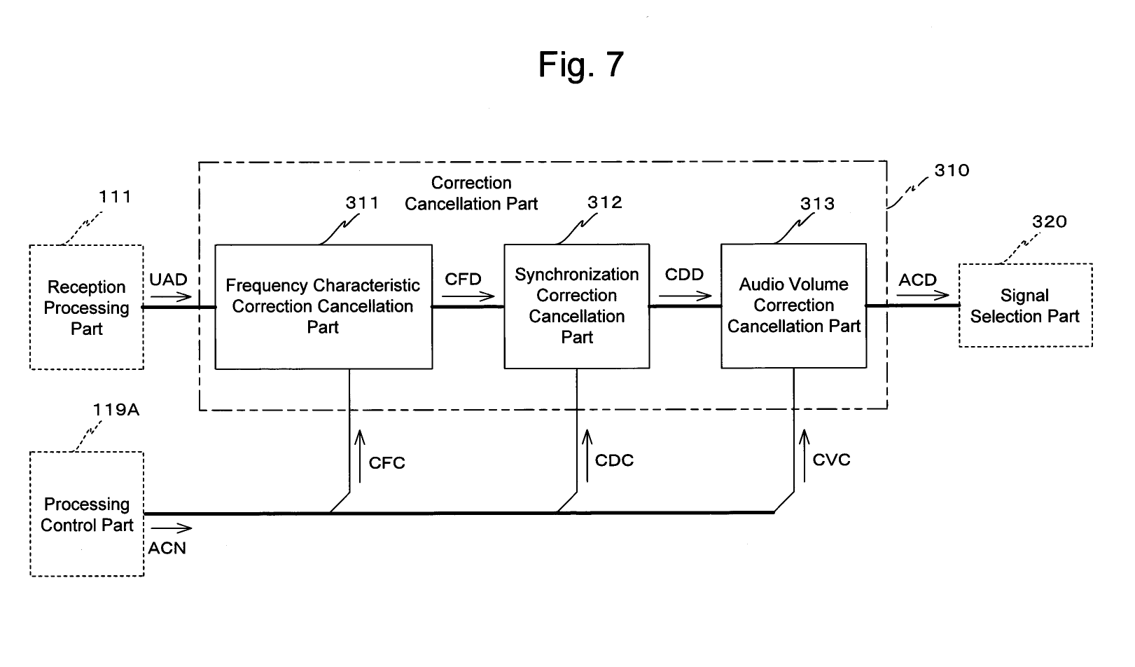

The correction cancellation part 310 described above receives the signal UAD from the reception processing part 111. According to a cancellation control command ACN in the replay generation command RGA, the correction cancellation part 310 cancels specific sound field correction carried out upon the signal UAD, and generates a signal ACD. Here, individual signals ACD_{L} through ACD_{SR} corresponding to the channels L through SR are included in this signal ACD. As shown in FIG. 7, this correction cancellation part 310 comprises a frequency characteristic correction cancellation part 311, a synchronization correction cancellation part 312, and an audio volume correction cancellation part 313.

The frequency characteristic correction cancellation part 311 described above receives the signal UAD from the reception processing part 111. And the frequency characteristic correction cancellation part 311 generates a signal CFD that includes individual signals CFD_{L} through CFD_{SR} in which the frequency characteristic correction in the specific sound field correction processing has been cancelled, by correcting the frequency characteristic of each of the individual signals UAD_{L} through UAD_{SR} in the signal UAD according to a frequency characteristic correction cancellation command CFC in the cancellation control command ACN. The signal CFD that has been generated in this manner is sent to the synchronization correction cancellation part 312.

It should be understood that the frequency characteristic correction cancellation part 311 comprises individual frequency characteristic correction means such as, for example, equalizer means or the like, provided for each of the individual signals UAD_{L} through UAD_{SR}. Furthermore, it is arranged for the frequency characteristic correction cancellation command CFC to include individual frequency characteristic correction cancellation commands CFC_{L} through CFC_{SR} corresponding to the individual signals UAD_{L} through UAD_{SR} respectively.

The synchronization correction cancellation part 312 described above receives the signal CFD from the frequency characteristic correction cancellation part 311. And the synchronization correction cancellation part 312 generates a signal CDD that includes individual signals CDD_{L} through CDD_{SR} in which the synchronization correction in the specific sound field correction processing has been cancelled by delaying and thus correcting each of the individual signals CFD_{L} through CFD_{SR} in the signal CFD according to a synchronization correction cancellation command CDC in the cancellation control command ACN. The signal CDD that has been generated in this manner is sent to the audio volume correction cancellation part 313.

It should be understood that the synchronization correction cancellation part 312 includes individual variable delay means that are provided for each of the individual signals CFD_{L} through CFD_{SR}. Furthermore, it is arranged for the synchronization correction cancellation command CDC to include individual synchronization correction cancellation commands CDC_{L} through CDC_{SR}, respectively corresponding to the individual signals CFD_{L} through CFD_{SR}.

The audio volume correction cancellation part 313 described above receives the signal CDD from the synchronization correction cancellation part 312. The audio volume correction cancellation part 313 generates a signal ACD that includes individual signals ACD_{L} through ACD_{SR} for which the audio volume balance correction in the specific sound field correction processing has been cancelled by performing audio volume correction of the audio volume of each of the respective individual signals CDD_{L} through CDD_{SR} in the signal CDD according to an audio volume correction cancellation command CVC in the cancellation control command ACN. The signal ACD that has been generated in this manner is sent to the signal selection part 320.

It should be understood that the audio volume correction cancellation part 313 includes individual audio volume correction means, for example variable attenuation means or the like, provided for each of the individual signals CDD_{L} through CDD_{SR}. Moreover, it is arranged for the audio volume correction cancellation command CVC to include individual audio volume correction cancellation commands CVC_{L} through CVC_{SR} corresponding respectively to the individual signals CDD_{L} through CDD_{SR}.

Returning to FIG. 6, the signal selection part 320 described above receives the signal ACD from the correction cancellation part 310 and the signals ND1 and ND2 from the reception processing part 111. According to the signal selection command SL2 in the replay generation command RGA, this signal selection part 320 selects one or the other of the signals ACD, ND1, and ND2 and sends that signal to the correction processing part 330 as the signal SND. Here, individual signals SND_{L} through SND_{SR} corresponding to the channels L through SR are included in this signal SND.

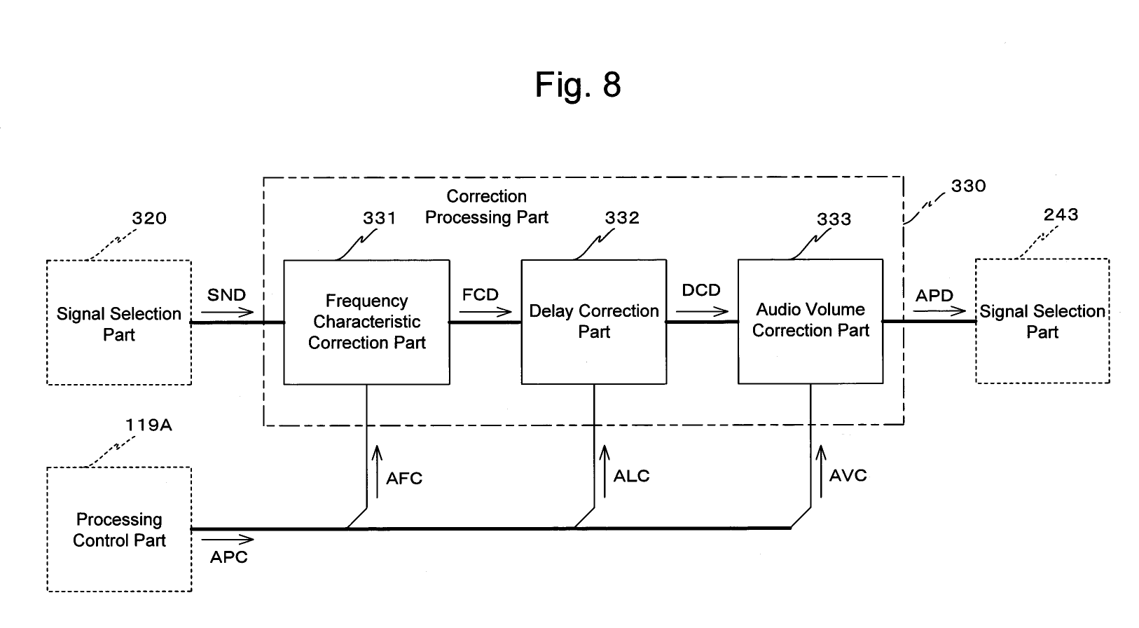

The correction processing part 330 described above receives the signal SND from the signal selection part 320. The correction processing part 330 performs sound field correction processing upon this signal SND, according to a correction control command APC in the replay generation command RGA. As shown in FIG. 8, this correction processing part 330 comprises a frequency characteristic correction part 331, a delay correction part 332, and an audio volume correction part 333.

The frequency characteristic correction part 331 described above receives the signal SND from the signal selection part 320. And the frequency characteristic correction part 331 generates a signal FCD that includes individual signals FCD_{L} through FCD_{SR} for which the frequency characteristic of each of the individual signals SND_{L} through SND_{SR} in the signal SND has been corrected according to a frequency characteristic correction command AFC in the correction control command APC. The signal FCD that has been generated in this manner is sent to the delay correction part 332.

It should be understood that the frequency characteristic correction part 331 comprises individual frequency characteristic correction means provided for each of the individual signals SND_{L} through SND_{SR}, for example equalizer means or the like. Furthermore, it is arranged for the frequency characteristic correction command AFC to include individual frequency characteristic correction commands AFC_{L} through AFC_{SR} respectively corresponding to the individual signals SND_{L} through SND_{SR}.

The delay correction part 332 described above receives the signal FCD from the frequency characteristic correction part 331. The delay correction part 332 generates a signal DCD that includes individual signals DCD_{L} through DCD_{SR} in which each of the individual signals FCD_{L} through FCD_{SR} in the signal FCD has been delayed according to a delay correction command ALC in the correction control command APC. The signal DCD that has been generated in this manner is sent to the audio volume correction part 333.

It should be understood that the delay correction part 332 comprises individual variable delay means provided for each of the individual signals FCD_{L} through FCD_{SR}. Furthermore, it is arranged for the delay correction command ALC to include individual delay correction commands ALC_{L} through ALC_{SR} respectively corresponding to the individual signals FCD_{L} through FCD_{SR}.

The audio volume correction part 333 described above receives the signal DCD from the delay correction part 332. The audio volume correction part 333 generates a signal APD that includes individual signals APD_{L} through APD_{SR} in which the audio volume of each of the individual signals DCD_{L} through DCD_{SR} in the signal DCD has been corrected according to an audio volume correction command AVC in the correction control command APC. The signal APD that has been generated in this manner is sent to the signal selection part 243.

It should be understood that the audio volume correction part 333 comprises individual audio volume correction means provided for each of the individual signals DCD_{L} through DCD_{SR}, for example variable attenuation means. Furthermore, it is arranged for the audio volume correction command AVC to include individual audio volume correction commands AVC_{L} through AVC_{SR} respectively corresponding to the individual signals DCD_{L} through DCD_{SR}.

Returning to FIG. 5, the test audio generation part 242 described above generates test audio data utilized in measurement for appropriate sound field correction processing corresponding to the sound field space ASP. This test audio generation part 242 generates test audio data of a type specified by a test audio generation command TSG in the generation control command GCA. Here, as test audio data, it is arranged for the test audio generation part 242 to be capable of generating pink noise audio data that is used, for example, in measurement for frequency characteristic correction and in measurement for audio volume balance correction, and pulse audio data that is used, for example, in measurement for synchronization correction processing. The test audio data that has been generated by the test audio generation part 242 is sent to the signal selection part 243 as a test audio data signal TSD.

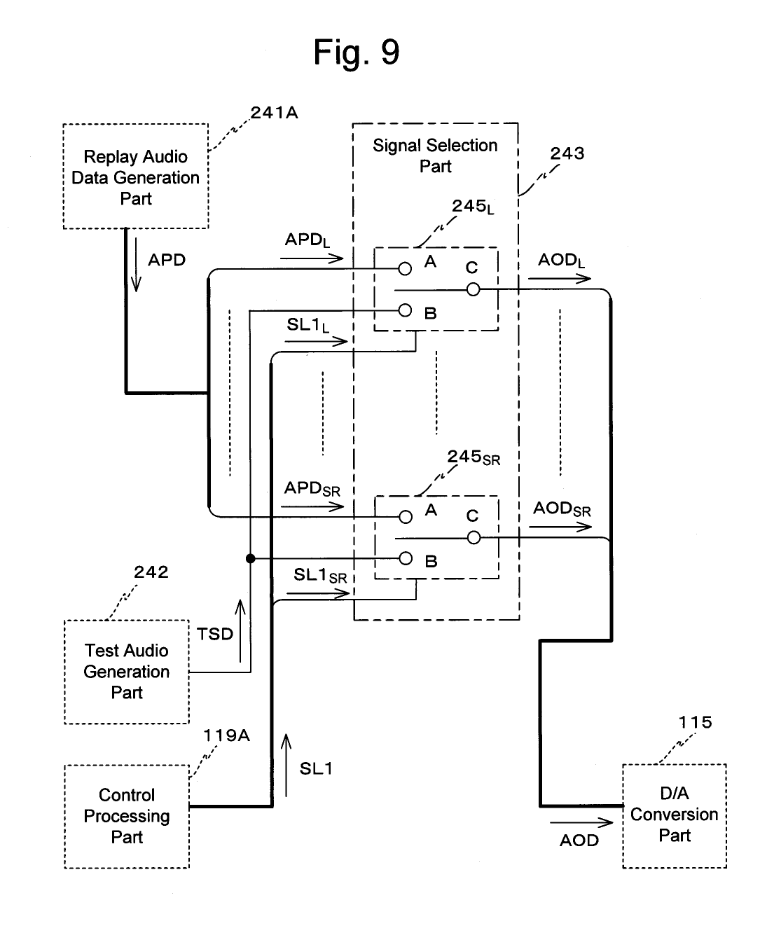

As shown in FIG. 9, the signal selection part 243 described above comprises four switching elements 245_{L} through 245_{SR}. Each of these switching elements 245_{L} through 245_{SR} has an A terminal and a B terminal which are input terminals, and also has a C terminal which is an output terminal. Along with the individual signals APDⱼ in the signal APD from the replay audio data generation part 241A being received by the switching elements 245ⱼ (where j=L through SR) at their A terminals, they also receive the test audio data signal TSD at their B terminals. According to the individual selection commands SL1ⱼ in the signal selection command SL1 from the control processing part 119A, either continuity is established between the A terminals and the C terminals, or continuity is established between the B terminals and the C terminals, or continuity is established neither between the A terminals and the C terminals nor between the B terminals and the C terminals. The signal AOD that is sent to the D/A conversion part 115 includes individual signals AODⱼ outputted from the C terminals of the switching elements 245ⱼ (this is to be understood as including the possibility of no such signals being present).

Returning to FIG. 3, the D/A conversion part 115 described above includes four D/A converters. This D/A conversion part 115 receives the signal AOD from the output audio data generation part 114A. The D/A conversion part 115 performs A/D conversion upon each of the individual signals AOD_{L} through AOD_{SR} included in the signal AOD, thus generating a signal ACS in analog format. The signal ACS that has been generated in this manner is sent to the amplification part 116. It should be understood that individual signals ACSⱼ resulting from D/A conversion of the individual signals AODⱼ (where j=L through SR) are included in the signal ACS.

It is arranged for the amplification part 116 described above to include four power amplification means. This amplification part 116 receives the signal ACS from the D/A conversion part 115. The amplification part 116 performs power amplification upon each of the individual signals ACS_{L} through ACS_{SR} included in the signal ACS, and thereby generates the output acoustic signal AOS. The individual output acoustic signals AOSⱼ (where j=L through SR) in the output acoustic signal AOS that has been generated in this manner are sent to the speaker units 910.

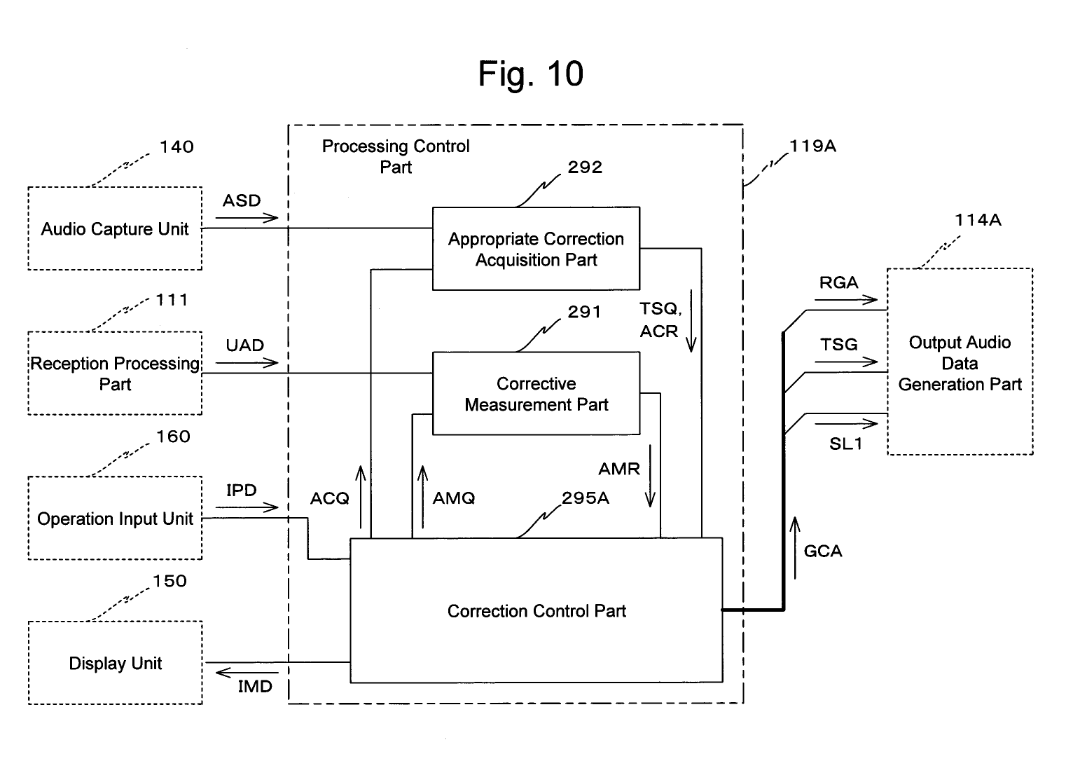

The processing control part 119A described above performs processing of various kinds, and controls the operation of the acoustic signal processing device 100A. As shown in FIG. 10, this processing control part 119A comprises a corrective measurement part 291 that serves as a measurement means, an appropriate correction acquisition part 292 that serves as an acquisition means, and a correction control part 295A.

The corrective measurement part 291 described above measures aspects of the specific sound field correction processing by the sound source device 920₀, based upon control by the correction control part 295A. During this measurement, audio contents for measurement recorded upon a recording medium for measurement are employed. It is arranged for the corrective measurement part 291 to analyze the signal UAD into which the acoustic signal UAS has been A/D converted by the reception processing part 111, and to measure aspects of the frequency characteristic correction processing, the synchronization correction processing, and the audio volume balance correction processing, included in the specific sound field correction processing. A corrective measurement result AMR results from this measurement by the corrective measurement part 291, and this is reported to the correction control part 295A.

Here, “frequency characteristic correction processing” means correction processing for the frequency characteristic that is carried out upon each of the individual acoustic signals in the original acoustic signal that correspond to the L through SR channels. Furthermore, “synchronization correction processing” means correction processing for the output timings of the audio outputted from each of the speaker units 910_{L} through 910_{SR}. Moreover, “audio volume balance correction processing” means balance correction processing between the speaker units 910_{L} through 910_{SR}, related to the output volumes of the audio from each of these speaker parts. It should be understood that the terms “frequency characteristic correction processing”, “synchronization correction processing”, and “audio volume balance correction processing” are intended to be used with similar meanings in the following explanation as well.

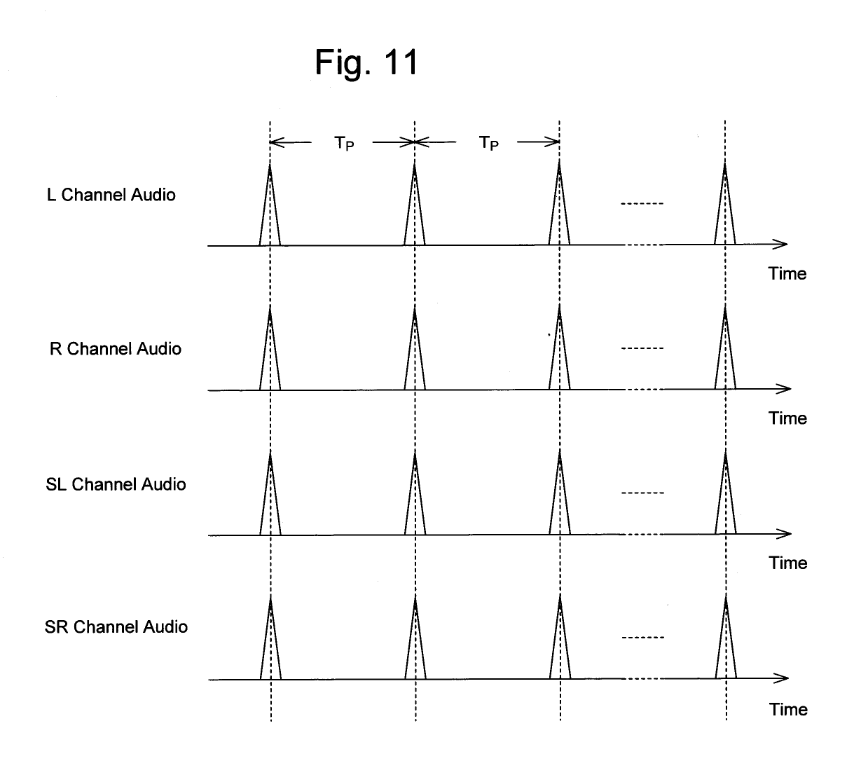

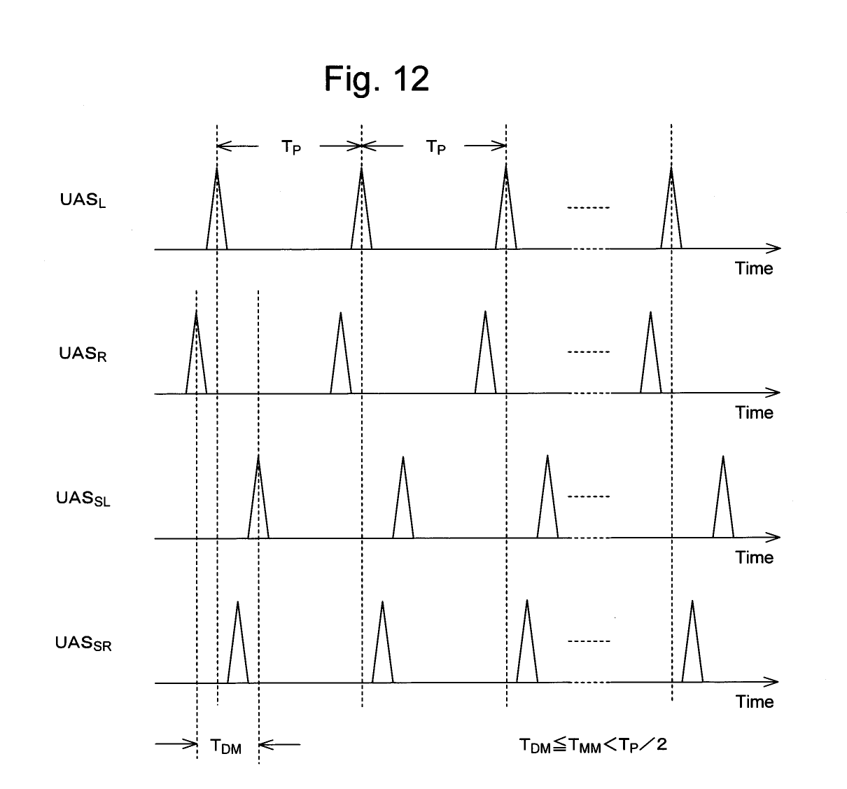

In this first embodiment, when measuring aspects of the synchronization correction processing in the specific sound field correction processing, as shown in FIG. 11, pulse form sounds generated simultaneously at a period T_{P} and corresponding to the channels L through SR are used as the audio contents for measurement. When sound field correction processing corresponding to the audio contents for synchronization measurement is carried out in this way upon the original acoustic signal by the sound source device 920₀, the acoustic signal UAS in which the individual acoustic signals UAS_{L} through UAS_{SR} are included is supplied to the control unit 110A as the result of this synchronization correction processing in the sound field correction processing, as for example shown in FIG. 12.

Here, for the period T_{P}, a time period is taken that is more than twice as long as the supposed maximum time period difference T_{MM} that is supposed to be the maximum delay time period difference T_{DM}, which is the maximum value of the delay time period differences imparted to the individual acoustic signals UAS_{L} through UAS_{SR} by the synchronization correction processing in the sound source device 920₀. Furthermore the corrective measurement part 291 measures aspects of the synchronization correction processing by the sound source device 920₀ by taking, as the subject of analysis, pulses in the individual acoustic signals UAS_{L} through UAS_{SR} after a time period of T_{P}/2 has elapsed after a pulse in any of the individual acoustic signals UAS_{L} through UAS_{SR} has been initially detected. By doing this, even if undesirably there is some deviation between the timing of generation of the acoustic signal UAS for the synchronization correction processing measurement, and the timing at which the signal UAD is obtained by the corrective measurement part 291, still the corrective measurement part 291 is able to perform measurement of aspects of the above synchronization correction processing correctly, since the pulses that are to be the subject of analysis are detected by the synchronization processing in order of shortness of delay time period.

The period T_{P} and the supposed maximum time period difference T_{MM} are determined in advance on the basis of experiment, simulation, experience, or the like, from the standpoint of correct and quick measurement of aspects of the synchronization correction processing.

On the other hand, when measuring aspects of the frequency characteristic correction processing and aspects of the audio volume balance correction processing, in this embodiment, it is arranged to utilize continuous pink noise sound as the audio contents for measurement.

Returning to FIG. 10, the appropriate correction acquisition part 292 described above acquires aspects of appropriate sound field correction processing corresponding to the sound field space ASP (refer to FIG. 2) on the basis of control by the correction control part 295A. It is arranged for this appropriate correction acquisition part 292 to acquire aspects of the frequency characteristic correction processing, of the synchronization correction processing, and of the audio volume balance correction processing, that are included in the appropriate sound field correction processing.

When acquiring these aspects of the appropriate sound field correction processing, the appropriate correction acquisition part 292 sequentially sends to the correction control part 295A, in a predetermined sequence, test audio output requests TSQ in which types of test audio and speaker parts for output of test audio are designated. And the appropriate correction acquisition part 292 acquires aspects of the appropriate sound field correction processing on the basis of the audio capture result data ASD from the audio capture unit 140 for the test audio outputted from the designated speaker parts. This appropriate correction acquisition result ACR, which is the result of acquisition by the appropriate correction acquisition part 292, is reported to the correction control part 295A.

It should be understood that, in this first embodiment, when acquiring aspects of the synchronization correction of the appropriate sound field correction processing, it is arranged for the appropriate correction acquisition part 292 to designate pulse audio data as the type for the test audio data. Furthermore, when acquiring aspects of the frequency characteristic correction and aspects of the audio volume balance correction of the appropriate sound field correction processing, it is arranged for the appropriate correction acquisition part 292 to designate pink noise audio data as the type for the test audio data.

Furthermore, in this first embodiment, it is arranged for the appropriate correction acquisition part 292 to acquire aspects of the three types of individual sound field correction processing in the appropriate sound field correction processing, i.e. of the frequency characteristic correction processing, of the synchronization correction processing, and of the audio volume balance correction processing, automatically in a predetermined sequence.

The correction control part 295A described above performs control processing corresponding to operations inputted by the user, received from the operation input unit 160 as the operation input data IPD. When the user inputs to the operation input unit 160 a designation of the type of acoustic signal that corresponds to the audio to be replay outputted, this correction control part 295A sends to the signal selection parts 243 (refer to FIGS. 5) and 320 (refer to FIG. 6) the signal selection commands SL1 and SL2 that are required in order for audio to be outputted from the speaker units 910_{L} through 910_{SR} on the basis of the designated acoustic signal.

For example, when the acoustic signal UAS is designated by the user, the correction control part 295A sends to the signal selection part 243, as the signal selection command SL1, a command to the effect that the signal APD is to be selected, and also sends to the signal selection part 320, as the signal selection command SL2, a command to the effect that the signal ACD is to be selected. Furthermore, when the acoustic signal NAS is designated by the user, the correction control part 295 sends to the signal selection part 243, as the signal selection command SL1, a command to the effect that the signal APD is to be selected, and also sends to the signal selection part 320, as the signal selection command SL2, a command to the effect that the signal ND1 is to be selected. Moreover, when the acoustic signal NAS is designated by the user, the correction control part 295A sends to the signal selection part 243, as the signal selection command SL1, a command to the effect that the signal APD is to be selected, and also sends to the signal selection part 320, as the signal selection command SL2, a command to the effect that the signal ND2 is to be selected.

Moreover, when the user has inputted to the operation input unit 160 a command for measurement of aspects of sound field correction processing by the sound source device 920₀, the correction control part 295A sends a measurement start command to the corrective measurement part 291 as a measurement control signal AMQ. It should be understood that in this embodiment it is arranged, after generation of the acoustic signal UAS has been performed by the sound source device 920₀ on the basis of the corresponding audio contents, for the user to input to the operation input unit 160 the type of correction processing that is to be the subject of measurement, for each individual correction processing that is to be a subject for measurement. Each time the measurement related to some individual correction processing ends, it is arranged for a corrective measurement result AMR that specifies the individual correction processing for which the measurement has ended to be reported to the correction control part 295A.

Furthermore, upon receipt from the corrective measurement part 291 of the corrective measurement result AMR as a result of individual correction processing measurement, and on the basis of this corrective measurement result AMR, the correction control part 295A issues that frequency characteristic correction cancellation command CFC, or that synchronization correction cancellation command CDC, or that audio volume correction cancellation command CVC, that is necessary in order to cancel aspects of that individual correction processing that has been measured. The frequency characteristic correction cancellation command CFC, the synchronization correction cancellation command CDC, or the audio volume correction cancellation command CVC that is generated in this manner is sent to the correction cancellation part 310 as a cancellation control command ACN (refer to FIG. 7). The type of this individual correction processing, and the fact that measurement thereof has ended, are displayed on the display device of the display unit 150.

Furthermore, when the user inputs to the operation input unit 160 an acquisition command for aspects of the appropriate sound field correction processing, then the correction control part 295A sends an acquisition start command to the appropriate correction acquisition part 292 as an acquisition control signal ACQ. When the correction control part 295A receives a test audio output request TSQ from the appropriate correction acquisition part 292 that has received this acquisition start command, then it first generates the signal selection command SL1 for outputting test audio from the speaker parts as specified by the test audio output request TSQ, and sends this command SL1 to the signal selection part 243. Next, the correction control part 295A generates a test audio generation command TSG in which test audio data of the type specified by the test audio output request TSQ is designated, and sends this command TSG to the test audio generation part 242.

Moreover, upon receipt of the appropriate correction acquisition result ACR from the appropriate correction acquisition part 292, the correction control part 295A generates a correction control command APC that includes the frequency characteristic correction command AFC, the delay correction command ALC, and the audio volume correction command AVC that are required for performing appropriate sound field correction processing on the basis of this appropriate correction acquisition result ACR. The correction control command APC that has been generated in this manner is sent to the correction processing part 330 (refer to FIG. 8). And the correction control part 295A displays upon the display device of the display unit 150 a message to the effect that acquisition of aspects of the appropriate sound field correction processing has ended.

### <Operation>

Next, the operation of this acoustic signal processing device 100A having the structure described above will be explained, with attention being principally directed to the processing by the processing control part 119A.

### <<Measurement of Aspects of the Specific Sound Field Correction Processing, and Setting of the Correction Cancellation Part 310>>

First, the processing for measurement of aspects of the specific sound field correction processing by the sound source device 920₀, and for setting the correction cancellation part 310, will be explained.

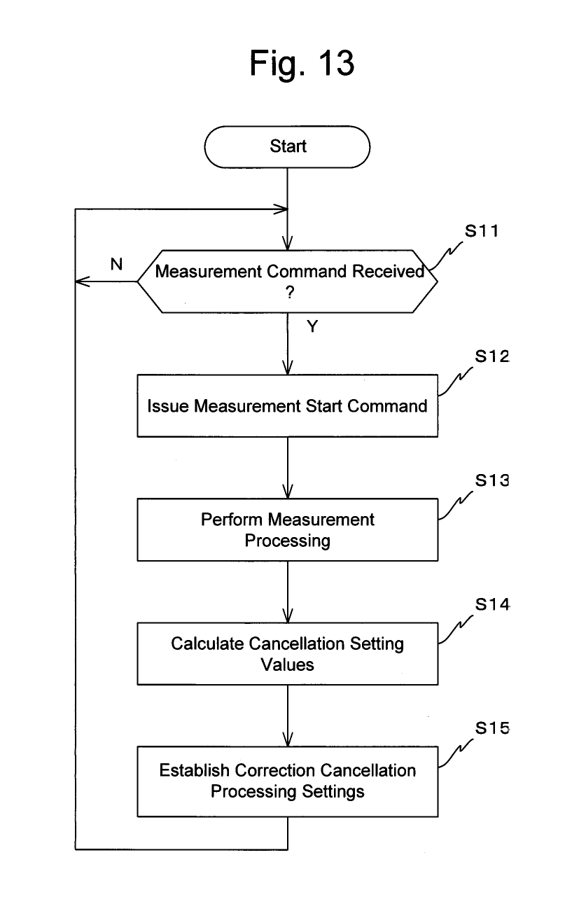

In this processing, as shown in FIG. 13, in a step S11, the correction control part 295 of the processing control part 119A makes a judgment as to whether or not a measurement command has been received from the operation input unit 160. If the result of this judgment is negative (N in the step S11), then the processing of this step S11 is repeated.

In this state, the user employs the operation input unit 160 and causes the sound source device 920₀ to start generation of the acoustic signal UAS on the basis of audio contents corresponding to the individual correction processing that is to be the subject of measurement. Next, when the user inputs to the operation input unit 160 a measurement command in which the individual correction processing that is to be the first subject of measurement is designated, this is taken as operation input data IPD, and a report to this effect is sent to the correction control part 295A.

Upon receipt of this report, the result of the judgment in the step S11 becomes affirmative (Y in the step S11), and the flow of control proceeds to a step S12. In this step S12, the correction control part 295A issues to the corrective measurement part 291, as a measurement control signal AMQ, a measurement start command in which is designated the individual measurement processing that was designated by the user in the measurement command.

Next, in a step S13, the corrective measurement part 291 measures that aspect of individual correction processing that was designated by the measurement start command. During this measurement, the corrective measurement part 291 gathers from the reception processing part 111 the signal levels of the individual signals UAD_{L} through UAD_{SR} in the signal UAD over a predetermined time period. And the corrective measurement part 291 analyzes the results that it has gathered, and measures that aspect of the individual correction processing.

Here, if the individual correction processing designated by the measurement start command is frequency characteristic correction processing, then first the corrective measurement part 291 calculates the frequency distribution of the signal level of each of the individual signals UAD_{L} through UAD_{SR} on the basis of the results that have been gathered. And the corrective measurement part 291 analyzes the results of these frequency distribution calculations, and thereby performs measurement for the frequency characteristic correction processing aspect. The result of this measurement is reported to the correction control part 295A as a corrective measurement result AMR.

Furthermore, if the individual correction processing that was designated by the measurement start command is synchronization correction processing, then first the corrective measurement part 291 starts gathering data, and specifies the timing at which each of the various individual signals UAD_{L} through UAD_{SR} goes into the signal present state, in which it is at or above an initially predetermined level. And, after time periods T_{P}/2 from these specified timings have elapsed, the corrective measurement part 291 specifies the timing at which each of the individual signals UAD_{L} through UAD_{SR} goes into the signal present state. The corrective measurement part 291 measures aspects of the synchronization correction processing on the basis of these results. The result of this measurement is reported to the correction control part 295A as a corrective measurement result AMR.

Moreover, if the individual correction processing that was designated by the measurement start command is audio volume balance correction processing, the corrective measurement part 291 then analyzes the results that it has gathered, and measures aspects of audio volume correction for each of the individual signals UAD_{L} through UAD_{SR}. The result of this measurement is reported to the correction control part 295A as a corrective measurement result AMR.

Next in a step S14, upon receipt of the corrective measurement result AMR and on the basis of this corrective measurement result AMR, the correction control part 295A calculates setting values for cancellation of individual correction processing by the correction cancellation part 310, according to an aspect that corresponds to these corrective measurement results AMR. For example, if a corrective measurement result AMR has been received that is related to aspects of the frequency characteristic correction processing, then the correction control part 295A calculates setting values that are required for setting the frequency characteristic correction cancellation part 311 of the correction cancellation part 310. Furthermore, if a corrective measurement result AMR has been received that is related to aspects of the synchronization correction processing, then the correction control part 295A calculates setting values that are required for setting the synchronization correction cancellation part 312 of the correction cancellation part 310. Moreover, if a corrective measurement result AMR has been received that is related to aspects of the audio volume balance correction processing, then the correction control part 295A calculates setting values that are required for setting the audio volume correction cancellation part 313 of the correction cancellation part 310.

Next in a step S15 the correction control part 295A sends the results of calculation of these setting values in the step S14 to the corresponding one of the frequency characteristic correction cancellation part 311, the synchronization correction cancellation part 312, and the audio volume correction cancellation part 313. Here, a frequency characteristic correction cancellation command CFC in which the setting values are designated is sent to the frequency characteristic correction cancellation part 311. Furthermore, a synchronization correction cancellation command CDC in which the setting values are designated is sent to the synchronization correction cancellation part 312. Moreover, an audio volume correction cancellation command CVC in which the setting values are designated is sent to the audio volume correction cancellation part 313. As a result, the individual correction processing that has been measured comes to be cancelled by the correction cancellation part 310.

When the measurements for aspects of individual measurement processing and establishment of the settings for the correction processing part 330 for aspects of individual correction processing on the basis of the measurement results have been completed in this manner, then the correction control part 295A displays a message to this effect upon the display device of the display unit 150.

Subsequently, the flow of control returns to the step S11. The processing of the steps S11 through S15 described above is repeated.

### <<Measurement of Aspects of the Appropriate Sound Field Correction Processing, and Setting of the Correction Processing Part 330>>

Next the measurement of aspects of the appropriate sound field correction processing, and the setting of the correction processing part 330, will be explained.

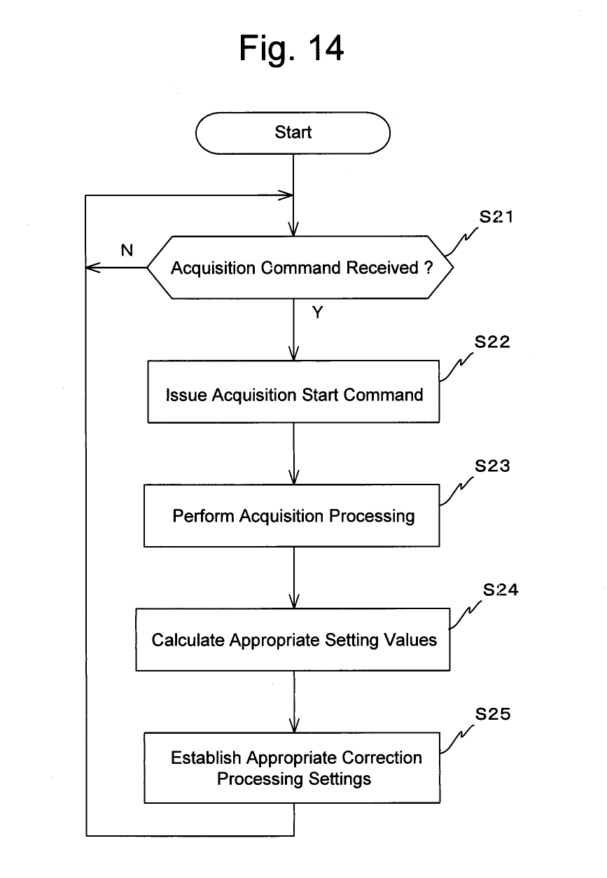

In this processing, as shown in FIG. 14, in a step S21, the correction control part 295A of the processing control part 119A makes a judgment as to whether or not an acquisition command has been received from the operation input unit 160. If the result of this judgment is negative (N in the step S21), then the processing of this step S21 is repeated.

When, in this state, the user inputs to the operation input unit 160 an acquisition command, this is taken as operation input data IPD, and a report to this effect is sent to the correction control part 295A. Upon receipt of this report, the result of the judgment in the step S21 becomes affirmative (Y in the step S21), and the flow of control proceeds to a step S22. In this step S22, the correction control part 295A issues to the corrective measurement part 291, as an acquisition control signal ACQ, an acquisition command for aspects of the appropriate sound field correction processing.

Next in a step S23 acquisition processing is performed for aspects of the appropriate sound field correction processing. During this acquisition processing, the appropriate correction acquisition part 292 sends to the correction control part 295A test audio output requests TSQ in which the types of test audio and the types of speaker part that are to output that test audio are specified, sequentially in a predetermined sequence. Each time one of these test audio output requests TSQ is received, the correction control part 295A generates a signal selection command SL1 and a test audio generation command TSG for outputting test audio of the type specified in that test audio output request TSQ from the speaker part of the type specified in that test audio output request TSQ, and sends them to the signal selection part 243 and to the test audio generation part 242.

As a result, test audio of the type specified in that test audio output request TSQ is outputted from the speaker part of the type specified in that test audio output request TSQ. In this manner, each time a test audio output request TSQ is received, the result of audio capture of output audio by the audio capture unit 140 is gathered by the appropriate correction acquisition part 292. And the appropriate correction acquisition part 292 analyzes the results that it has gathered, and thereby acquires aspects of the appropriate sound field correction processing. This acquisition result is reported to the correction control part 295A as an appropriate correction acquisition result ACR.

Next in a step S24, upon receipt of the report of the appropriate correction acquisition result ACR, and on the basis of this appropriate correction acquisition result ACR, the correction control part 295A calculates setting values for appropriate sound field correction to be performed by the correction processing part 330. And next in a step S25 the correction control part 295A sends the results of calculation of these setting values in the step S24 to the correction processing part 330. As a result, the appropriate sound field correction processing comes to be carried out upon the signal SND by the correction processing part 330.

When the acquisition of aspects of the appropriate sound field correction processing and the setting of the correction processing part 330 on the basis of the results of this acquisition have been completed in this manner, then the correction control part 295A displays a message to this effect upon the display device of the display unit 150.

Subsequently the flow of control returns to the step S21. The processing of the steps S21 through S25 described above is repeated.

### <<Processing Corresponding to Selection of the Audio to be Replayed>>

Next, the processing for selecting the audio to be replay outputted from the speaker units 910_{L} through 910_{SR} will be explained.

When the user inputs to the operation input unit 160 a designation of the type of acoustic signal that corresponds to the audio that is to be replayed and outputted from the speaker units 910_{L} through 910_{SR}, then a message to this effect is reported to the correction control part 295A as operation input data IPD. Upon receipt of this report, the correction control part 295A sends to the signal selection parts 243 and 320 those signal selection commands SL1 and SL2 that are required in order for audio on the basis of that designated acoustic signal to be outputted from the speaker units 910_{L} through 910_{SR}.

Here, if the acoustic signal UAS is designated, then the correction control part 295A sends to the signal selection part 243, as the signal selection command SL1, a command to the effect that the signal APD should be selected, and also sends to the signal selection part 320, as the signal selection command SL2, a command to the effect that the signal ACD should be selected. As a result, output acoustic signals AOS_{L} through AOS_{SR} are supplied to the speaker units 910_{L} through 910_{SR} in a state in which appropriate sound field correction processing has been carried out upon the original acoustic signals in the acoustic signal UAS, after the above described measurement processing for aspects of the specific sound field correction processing, cancellation setting for the correction cancellation part 310 for the specific sound field correction processing, and processing for acquisition of aspects of the appropriate sound field correction processing and processing for setting the correction processing part 330 have been completed.

Furthermore, if the acoustic signal NAS is designated, then the correction control part 295A sends to the signal selection part 243, as the signal selection command SL1, a command to the effect that the signal APD should be selected, and also sends to the signal selection part 320, as the signal selection command SL2, a command to the effect that the signal ND1 should be selected. As a result, after the above described acquisition processing for aspects of the appropriate sound field correction processing and processing for establishment of settings for the correction processing part 330 have been completed, output acoustic signals AOS_{L} through AOS_{SR} are supplied to the speaker units 910_{L} through 910_{SR} in a state in which appropriate sound field correction processing has been carried out upon the acoustic signal NAS.

Moreover, if the acoustic signal NAD is designated, then the correction control part 295A sends to the signal selection part 243, as the signal selection command SL1, a command to the effect that the signal APD should be selected, and also sends to the signal selection part 320, as the signal selection command SL2, a command to the effect that the signal ND2 should be selected. As a result, after having completed the above described acquisition processing for aspects of the appropriate sound field correction processing, and after setting processing for the correction processing part 330 has been completed, output acoustic signals AOS_{L} through AOS_{SR} are supplied to the speaker units 910_{L} through 910_{SR} in a state in which appropriate sound field correction processing has been carried out upon the acoustic signal NAD.

As has been explained above, in this first embodiment, the corrective measurement part 291 of the processing control part 119A measures aspects of the specific sound field correction processing carried out upon the acoustic signal UAS received from the sound source device 920₀, which is a specified external device. Settings for cancelling the specific sound field correction processing performed upon the acoustic signal UAS are established for the correction cancellation part 310 on the basis of the result of this measurement.

Moreover, aspects of the appropriate sound field processing corresponding to the actual sound field space ASP are acquired by the appropriate correction acquisition part 292 of the processing control part 119A. And settings for carrying out appropriate sound field correction processing upon the signal SND are set for the correction processing part 330 on the basis of the results of this acquisition.

Accordingly it is possible to supply output acoustic signals AOS_{L} through AOS_{SR} to the speaker units 910_{L} through 910_{SR} in a state in which sound field correction processing has been appropriately carried out, whichever of the acoustic signals UAS, NAS, and NAD may be selected.

Moreover, in this first embodiment, when measuring the synchronization correction processing aspects included in the sound field correction processing by the sound source device 920₀, sounds in pulse form that are generated simultaneously for the L through SR channels at the period T_{P} are used as the audio contents for measurement. Here, a time period is taken for the period T_{P} that is more than twice as long as the supposed maximum time period difference T_{MM} that is supposed to be the maximum delay time period difference T_{DM}, which is the maximum value of the delay time period differences imparted to the individual acoustic signals UAS_{L} through UAS_{SR} by the synchronization correction processing by the sound source device 920₀. Due to this, provided that the maximum delay time period difference T_{DM} is less than or equal to the supposed maximum time period difference T_{MM}, then, even if the timing of generation of the acoustic signal UAD for the measurement in the synchronization correction processing and the timing at which the signal UAD is collected by the corrective measurement part 291 are initially deviated from one another, which is undesirable, nevertheless it is possible for the corrective measurement part 291 correctly to measure aspects of synchronization correction processing by the sound source device 920₀ by analyzing change of the signal UAD, after the no-signal interval of the signal UAD has continued for the time period T_{P}/2 or longer.

### The Second Embodiment

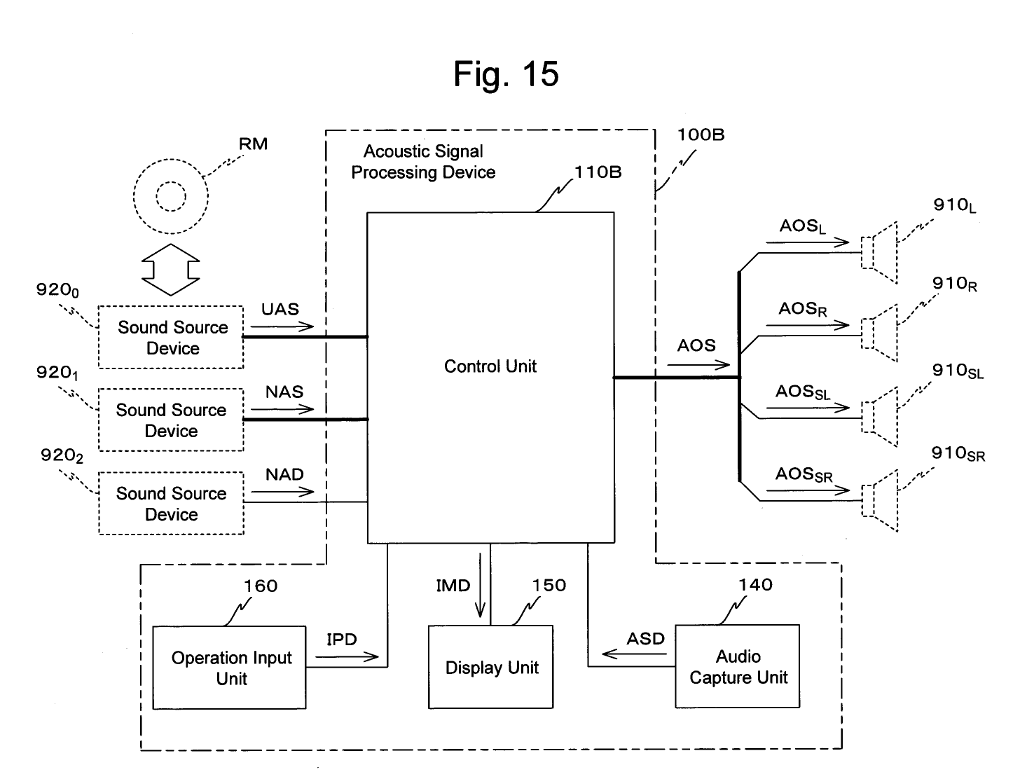

Next, the second embodiment of the present invention will be explained with principal reference to FIGS. 15 through 22.

### <Structure>

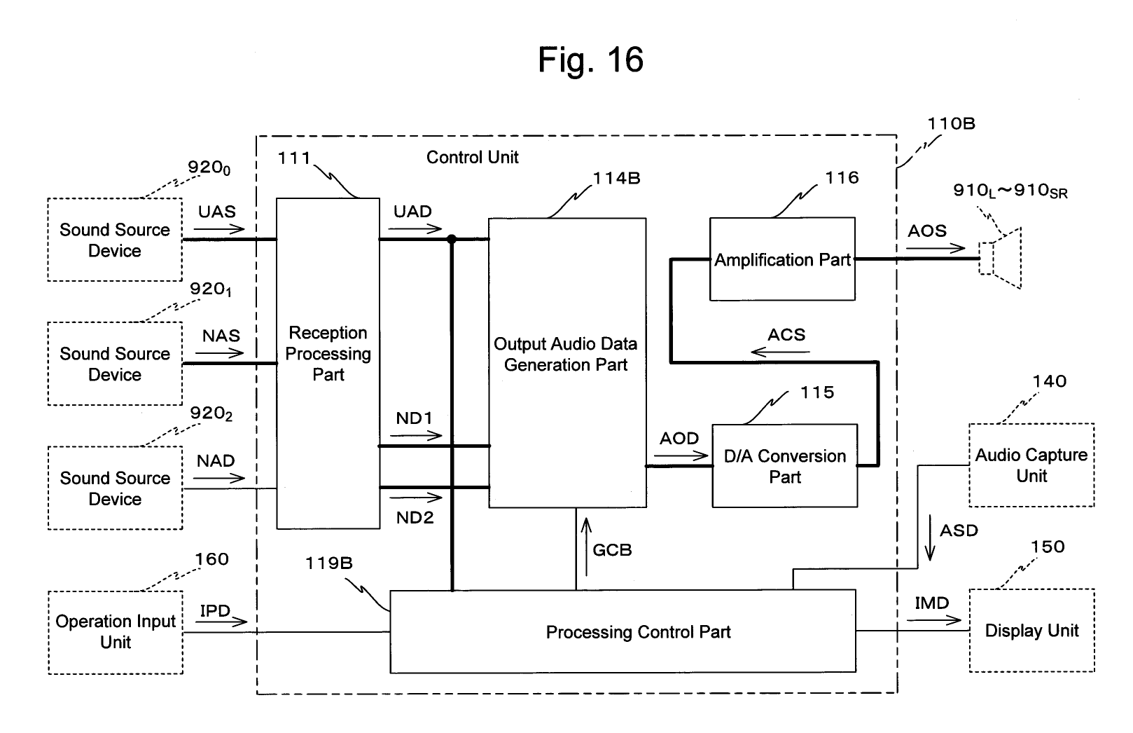

The schematic structure of an acoustic signal processing device 100B according to the second embodiment is shown in FIG. 15. As shown in this FIG. 15, as compared to the acoustic signal processing device 100A of the first embodiment described above (refer to FIG. 1), this acoustic signal processing device 100B only differs by the feature that a control unit 110B is provided, instead of the control unit 110A. And, as shown in FIG. 16, as compared with the control unit 110A described above (refer to FIG. 3), this control unit 110B only differs by the features that an output audio data generation part 114B is provided, instead of the output audio data generation part 114A, and that a processing control part 119B is provided, instead of the processing control part 119A.

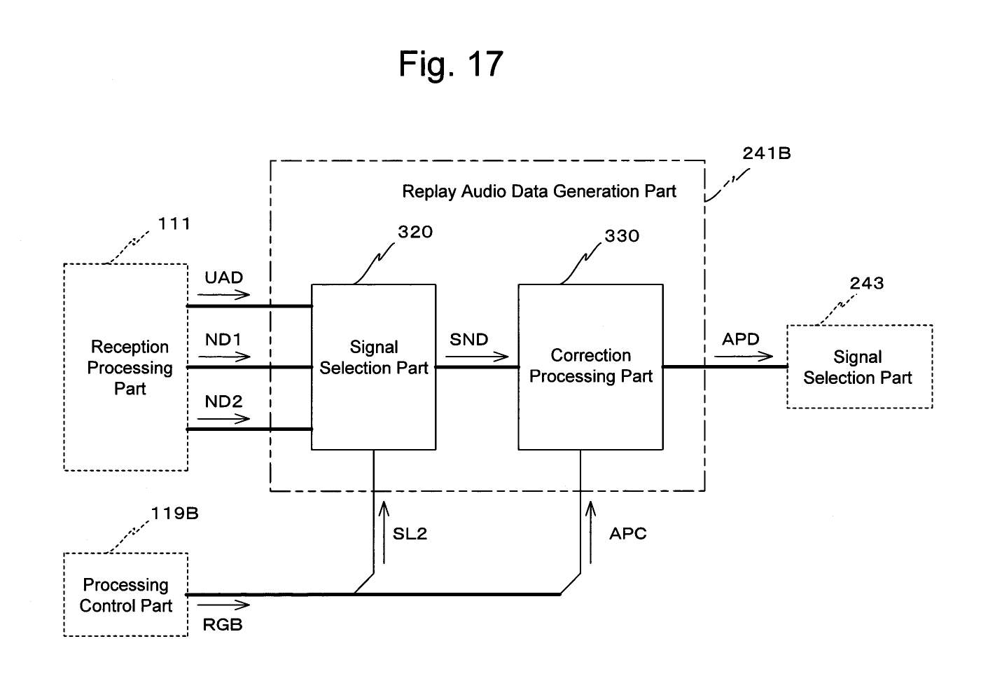

As compared to the output audio data generation part 114A described above (refer to FIG. 5), the output audio data generation part 114B mentioned above only differs by the feature that, instead of the replay audio data generation part 241A, a replay audio data generation part 241B having a structure as shown in FIG. 17 is provided. And, as compared to the replay audio data generation part 241A described above (refer to FIG. 6), this replay audio data generation part 241B only differs by the feature that no correction cancellation part 310 is provided, so that the signal UAD from the reception processing part 111 is sent directly to the signal selection part 320.

Due to this, as compared with the replay generation command RGA described above, the replay generation command RGB that is supplied from this control processing part 119B to this replay audio data generation part 241B differs by the feature that no cancellation control command ACN is included. It should be understood that, as compared to the generation control command GCA described above (refer to FIGS. 3 and 5), the output generation command GCB (refer to FIG. 16) supplied from the control processing part 119B to the output audio data generation part 114B differs by the feature that a replay generation command RGB is included, instead of the replay generation command RGA.

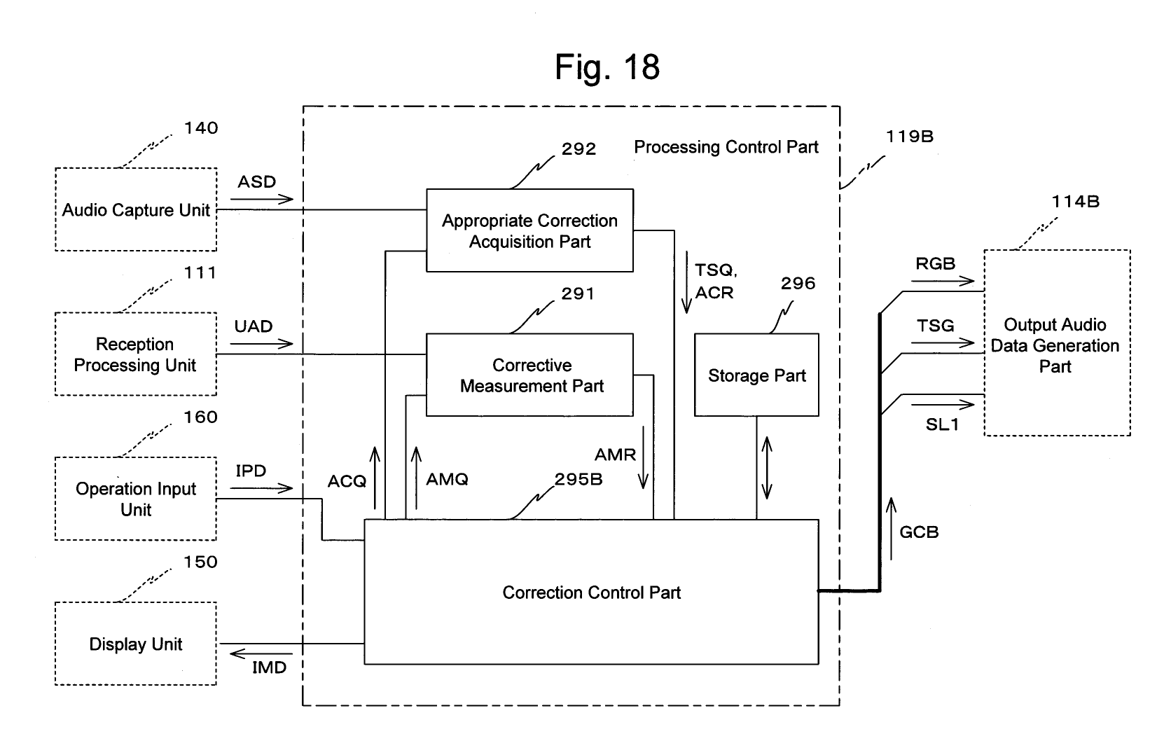

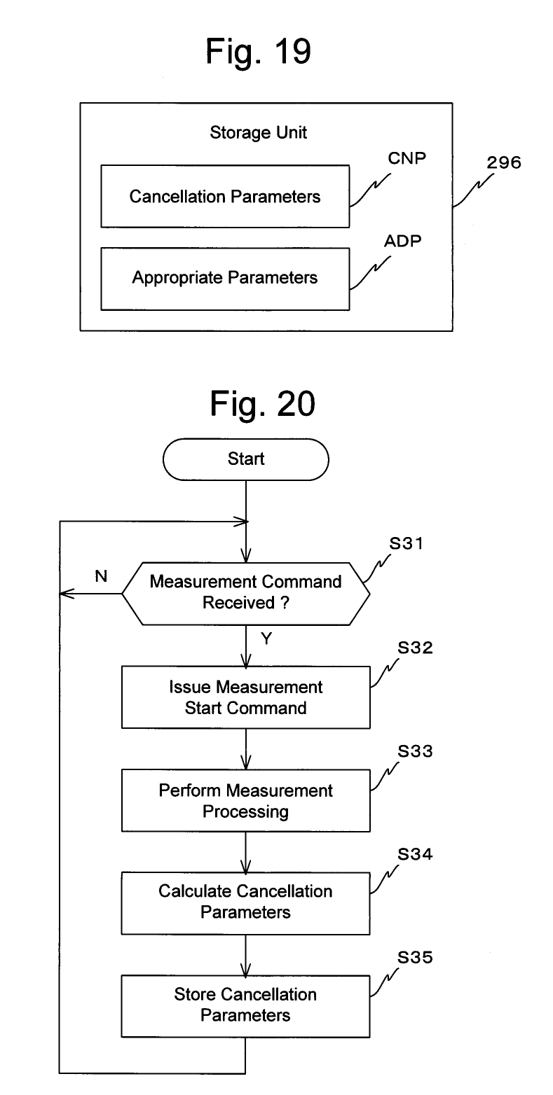

As shown in FIG. 18, as compared to the processing control part 119A described above (refer to FIG. 10), the processing control part 119B described above differs by the feature that it comprises a correction control part 295B instead of the correction control part 295A, and by the feature that it further comprises a storage part 296. Here, as shown in FIG. 19, cancellation parameters CNP and appropriate parameters ADP are stored in this storage part 296.

Returning to FIG. 18, the correction control part 295B described above performs control procedures corresponding to the operation input from the user that has been received from the operation input unit 160 as the operation input data IPD. When the user has inputted to the operation input unit 160 a measurement command for aspects of the sound field correction processing by the sound source device 920₀, the correction control part 295B sends a measurement start command to the corrective measurement part 291 as a measurement control signal AMQ, in a similar manner to the case with the correction control part 295A.

Furthermore, when the user has inputted to the operation input unit 160 an acquisition command for aspects of the appropriate sound field correction processing, in a similar manner to the correction control part 295A, the correction control part 295B sends an acquisition start command to the appropriate correction acquisition part 292 as an acquisition control signal ACQ. And, upon receipt of a test audio output request TSQ from the appropriate correction acquisition part 292 that has received this acquisition start command, in a similar manner to the correction control part 295A, the correction control part 295B first generates a signal selection command SL1 for outputting from the speaker parts the test audio designated in the test audio output request TSQ, and sends this command to the signal selection part 243. Next, in a similar manner to the correction control part 295A, the correction control part 295B generates a test audio generation command TSG in which is designated test audio data of the type specified by the audio output request TSQ, and sends it to the test audio generation part 242.

Furthermore, upon receipt from the corrective measurement part 291 of a corrective measurement result AMR as the result of individual correction processing measurement, on the basis of this corrective measurement result AMR, the correction control part 295B calculates cancellation parameters for cancelling aspects of individual correction processing that have been measured. And the correction control part 295B updates the cancellation parameters CNP in the storage part 296 by storing the results of this calculation of the individual cancellation parameters in the storage part 296. And the correction control part 295B displays the type of this individual correction processing and a message to the effect that measurement thereof has been completed upon the display device of the display unit 150.

Furthermore, upon receipt of an appropriate correction acquisition result ACR from the appropriate correction acquisition part 292, on the basis of this appropriate correction acquisition result ACR, the correction control part 295B calculates the appropriate parameters required for performing appropriate sound field correction processing. The correction control part 295B updates the appropriate parameters ADP in the storage part 296 by storing the results of this calculation of the appropriate parameters in the storage part 296. And the correction control part 295B displays a message to the effect that acquisition of aspects of appropriate sound field correction processing has been completed upon the display device of the display unit 150.

Furthermore, when the user inputs to the operation input unit 160 a designation of the type of acoustic signal which corresponds to audio to be replay outputted from the speaker units 910_{L} through 910_{SR}, on the basis of this designated acoustic signal, the correction control part 295B performs the necessary settings for audio upon which the appropriate sound field correction processing has been carried out to be outputted from the speaker units 910_{L} through 910_{SR}. In these settings, there are included a setting for the correction processing part 330 according to the correction control command APC, and settings for the signal selection parts 243 and 320 according to the signal selection commands SL1 and SL2.

For example, when the acoustic signal UAS is designated by the user, the correction control part 295B first reads out the cancellation parameters CNP and the appropriate parameters ADP from the storage part 296. Next, the correction control part 295B calculates differential parameters by adding together the appropriate parameters ADP and the cancellation parameters CNP. And, on the basis of these differential parameters that have been calculated, the correction control part 295B generates a correction control command APC that includes a frequency characteristic correction command AFC, a delay correction command ALC, and an audio volume correction command AVC that are required for carrying out the appropriate sound field correction processing.

The correction control part 295B sends the correction control command APC that has been generated in this manner to the correction processing part 330. Subsequently, the correction control part 295B sends a message to the effect that the signal APD is to be selected to the signal selection part 243 as the signal selection command SL1, and also sends a message to the effect that the signal ACD is to be selected to the signal selection part 320 as the signal selection command SL2.

Moreover, when the acoustic signal NAS is designated by the user, the correction control part 295B first reads out the appropriate parameters ADP from the storage part 296. And, on the basis of these appropriate parameters, the correction control part 295B generates a correction control command APC that includes a frequency characteristic correction command AFC, a delay correction command ALC, and an audio volume correction command AVC that are required for carrying out the appropriate sound field correction processing.

The correction control part 295B sends the correction control command APC that has been generated in this manner to the correction processing part 330. Subsequently, the correction control part 295B sends a message to the effect that the signal APD is to be selected to the signal selection part 243 as the signal selection command SL1, and also sends a message to the effect that the signal ND1 is be selected to the signal selection part 320 as the signal selection command SL2.

Furthermore, when the acoustic signal NAD is designated by the user, in a similar manner to the case in which the acoustic signal NAS has been designated, the correction control part 295B first reads out the appropriate parameters ADP from the storage part 296. And, on the basis of these appropriate parameters, the correction control part 295B generates a correction control command APC that includes a frequency characteristic correction command AFC, a delay correction command ALC, and an audio volume correction command AVC that are required for carrying out the appropriate sound field correction processing.

The correction control part 295B sends the correction control command APC that has been generated in this manner to the correction processing part 330. Subsequently, the correction control part 295B sends a message to the effect that the signal APD is to be selected to the signal selection part 243 as the signal selection command SL1, and also sends a message to the effect that the signal ND2 is to be selected to the signal selection part 320 as the signal selection command SL2. causes to show

### <Operation>

Next, the operation of the acoustic signal processing device 100B having the structure as described above will be explained, with attention being principally directed to the processing by the processing control part 119B.

### <<Measurement of Aspects of the Specific Sound Field Correction Processing>>

First, the processing for measurement of aspects of the specific sound field correction processing by the sound source device 920₀ will be explained.

In this processing, as shown in FIG. 20, in steps S31 through S33, similar processing is performed to the steps S11 through S13 of FIG. 13 described above, and aspects of the individual sound field correction processing for the specific sound field correction processing specified by the measurement command are measured. The result of this measurement is reported to the correction control part 295B as a corrective measurement result AMR.

Next, in a step S34, upon receipt of this report of the corrective measurement result AMR, and on the basis of this corrective measurement result AMR, the correction control part 295B calculates cancellation parameters that are required for cancelling aspects of the individual correction processing that has been measured. Next, in a step S35, the correction control part 295B updates the cancellation parameters CNP in the storage part 296 by storing the results of calculation of these individual cancellation parameters in the storage part 296. The correction control part 295B displays the type of this individual correction processing and the fact that measurement has been completed upon the display device of the display unit 150.

Subsequently the flow of control returns to the step S31. The processing from the step S31 to the step S35 described above is repeated.

### <<Acquisition of Aspects of the Appropriate Sound Field Correction Processing>>

Next, the acquisition processing for aspects of the appropriate sound field correction processing will be explained.

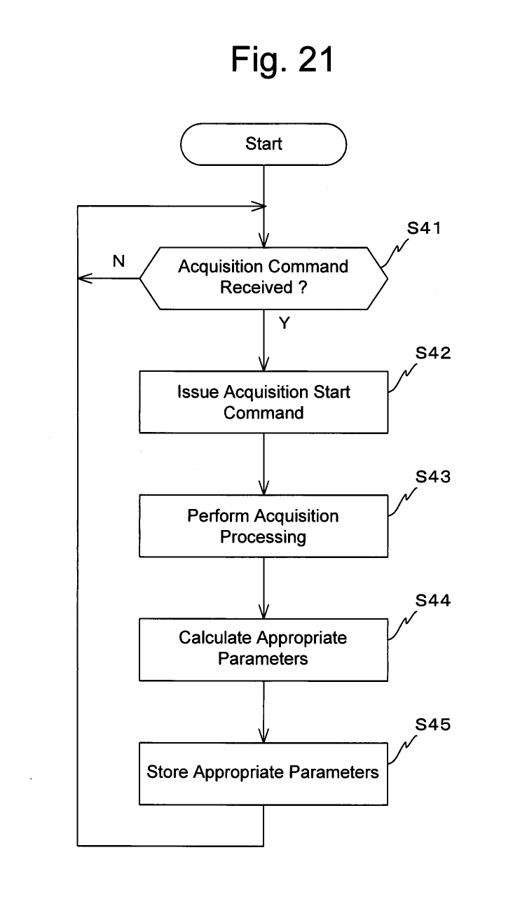

In this processing, as shown in FIG. 21, in steps S41 through S43, similar processing is performed to the case of the steps S21 through S23 in FIG. 14 described above, and aspects of the appropriate sound field correction processing are acquired. And this acquisition result is reported to the correction control part 295B as an appropriate correction acquisition result ACR.

Next, in a step S44, upon receipt of this appropriate correction acquisition result ACR, and on the basis of this appropriate correction acquisition result ACR, the correction control part 295B calculates appropriate parameters that are necessary for carrying out the appropriate sound field correction processing. Next, in a step S45, the correction control part 295B updates the appropriate parameters ADP in the storage part 296 by storing the results of this calculation of appropriate parameters in the storage part 296. The correction control part 295B displays a message to the effect that the appropriate sound field correction processing has been completed upon the display device of the display unit 150.

Subsequently the flow of control returns to the step S41. The processing from the step S41 to the step S45 described above is repeated.

### <<Generation of the Replay Audio>>

Next, the generation processing for the audio to be replay outputted from the speaker units 910_{L} through 910_{SR} will be explained.

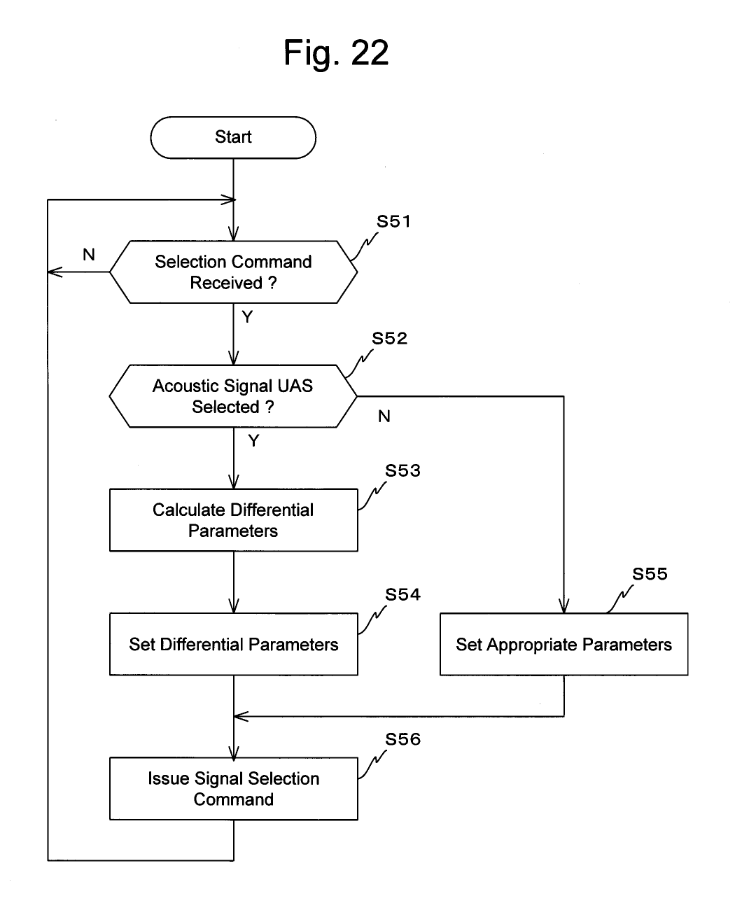

In this processing, as shown in FIG. 22, first in a step S51 the correction control part 295B of the processing control part 119B makes a judgment as to whether or not a replay audio selection command has been received from the operation input unit 160. If the result of this judgment is negative (N in the step S51), then the processing of the step S51 is repeated.

When, in this state, the user utilizes the operation input unit 160 and inputs a selection command for replay audio to the operation input unit 160, a message to this effect is reported to the correction control part 295B as operation input data IPD. Upon receipt of this report, the judgment result in the step S51 becomes affirmative (Y in the step S51), and the flow of control proceeds to a step S52.

In the step S52, a judgment is made as to whether or not the replay audio that has been selected is audio that corresponds to the acoustic signal UAS. If the result of this judgment is affirmative (Y in the step S52), the flow of control then proceeds to a step S53. In this step S53, differential parameters are calculated. During the calculation of these differential parameters, first, the correction control part 295B reads out the cancellation parameters CNP and the appropriate parameters ADP from the storage part 296. Next, the correction control part 295B adds together the appropriate parameters ADP and the cancellation parameters CNP, and thus calculates the differential parameters.

Next, in a step S54, on the basis of these differential parameters that have been calculated, the correction control part 295B generates a correction control command APC that includes a frequency characteristic correction command AFC, a delay correction command ALC, and an audio volume correction command AVC that are required for performing appropriate sound field correction processing. Then the correction control part 295B sends to the correction processing part 330 this correction control command APC that has been generated. As a result, sound field correction processing in which the specific sound field correction processing is subtracted from the appropriate sound field correction processing comes to be carried out by the correction processing part 330.

On the other hand, if the result of the judgment in the step S52 is negative (N in the step S52), then the flow of control proceeds to a step S55. In this step S55, first, the correction control part 295B reads out the appropriate parameters ADP from the storage part 296. On the basis of these appropriate parameters, the correction control part 295B generates a correction control command APC including a frequency characteristic correction command AFC, a delay correction command ALC, and an audio volume correction command AVC, required for performing sound field correction processing in an appropriate manner. And the correction control part 295B sends this correction control command APC that has been generated to the correction processing part 330. As a result, appropriate sound field correction processing comes to be carried out by the correction processing part 330.

As explained above, when the setting of the correction processing part 330 ends, in a step S56, the correction control part 295B sends to the signal selection parts 243 and 320 the signal selection commands SL1 and SL2 that are required for audio based upon the designated acoustic signal to be outputted from the speaker units 910_{L} through 910_{SR}.

Here, if the acoustic signal UAS has been designated, then the correction control part 295B sends to the signal selection part 243, as the signal selection command SL1, a message to the effect that the signal APD is to be selected, and also sends to the signal selection part 320, as the signal selection command SL2, a message to the effect that the signal UAD is to be selected. As a result, output acoustic signals AOS_{L} through AOS_{SR} in a state in which appropriate sound field correction processing has been carried out upon the original acoustic signal, which is the acoustic signal UAS, are supplied to the speaker units 910_{L} through 910_{SL}.

Furthermore, if the acoustic signal NAS has been designated, then the correction control part 295B sends to the signal selection part 243, as the signal selection command SL1, a message to the effect that the signal APD is to be selected, and also sends to the signal selection part 320, as the signal selection command SL2, a message to the effect that the signal ND1 is to be selected. As a result, output acoustic signals AOS_{L} through AOS_{SR} in the state in which appropriate sound field correction processing has been carried out upon the acoustic signal NAS are supplied to the speaker units 910_{L} through 910_{SL}.

Furthermore, if the acoustic signal NAD has been designated, then the correction control part 295B sends to the signal selection part 243, as the signal selection command SL1, a message to the effect that the signal APD is to be selected, and also sends to the signal selection part 320, as the signal selection command SL2, a message to the effect that the signal ND2 is to be selected. As a result, output acoustic signals AOS_{L} through AOS_{SR} in the state in which appropriate sound field correction processing has been carried out upon the acoustic signal NAD are supplied to the speaker units 910_{L} through 910_{SL}.

As has been explained above, in this second embodiment, the corrective measurement part 291 of the processing control part 119B measures aspects of the specific sound correction processing that is carried out upon the acoustic signal NAS received from the sound source device 920₀, which is a specific external device. Furthermore, the appropriate correction acquisition part 292 of the processing control part 119B acquires aspects of the appropriate sound field correction processing that corresponds to the actual sound field space ASP.

If it has been selected to perform replay output of audio corresponding to the acoustic signal UAS upon which the specific sound field correction processing is performed, then a setting is made for the correction processing part 330 to perform sound field correction processing of aspects with the specific sound field correction processing being subtracted from the appropriate sound field correction processing. Furthermore, if it has been selected to perform replay output of audio corresponding to the acoustic signal NAS or the acoustic signal NAD upon which no sound field correction processing has been performed, settings are then performed upon the correction processing part 330 to perform the appropriate sound field correction processing.

Accordingly, whichever of the acoustic signals UAS, NAS, and NAD may be selected, it is possible to supply output acoustic signals AOS_{L} through AOS_{SR} to the speaker units 910_{L} through 910_{SR} in a state in which appropriate sound field correction processing has been carried out thereupon.

Furthermore, if it has been selected to perform replay output of audio corresponding to the acoustic signal UAS, then, since the sound field correction processing of this aspect is performed by subtracting the specific sound field correction processing from the appropriate sound field correction processing, accordingly, as compared with a case in which appropriate sound field correction processing is performed after having performed processing to cancel the specific sound field correction processing, it is normally possible to reduce the amount of correction carried out upon the actual acoustic signal, so that it becomes possible to suppress sound quality deterioration created by the sound field correction processing.

Furthermore, in this second embodiment, in a similar manner to the case with the first embodiment, when measuring aspects of the synchronization correction processing that is included in the sound field correction processing by the sound source device 920₀, sounds in pulse form generated simultaneously at the period T_{P} and corresponding to the L channel through the SR channel is used as the audio contents for measurement. Due to this, in a similar manner to the case with the first embodiment, it is possible correctly to measure aspects of synchronization correction processing by the sound source device 920₀ by the corrective measurement part 291 analyzing change of the signal UAD after the no-signal interval of the signal UAD has continued for at least the time period T_{P}/2.

### The Third Embodiment

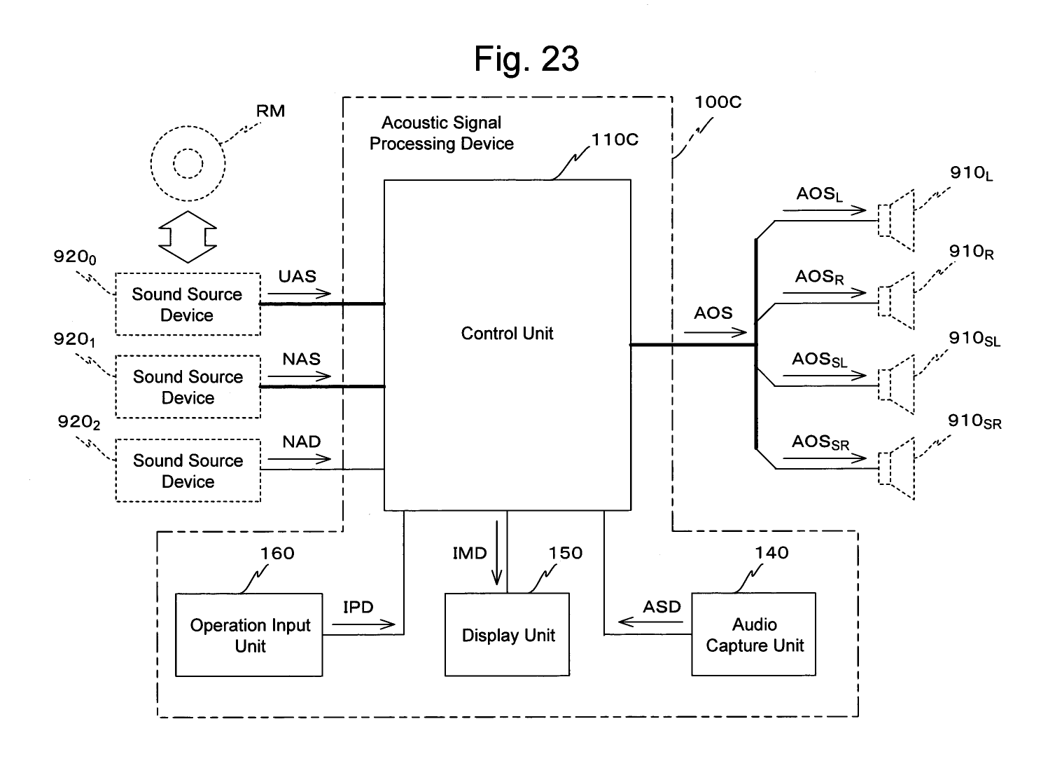

Next, the third embodiment of the present invention will be explained with principal reference to FIGS. 23 through 27.

### <Structure>

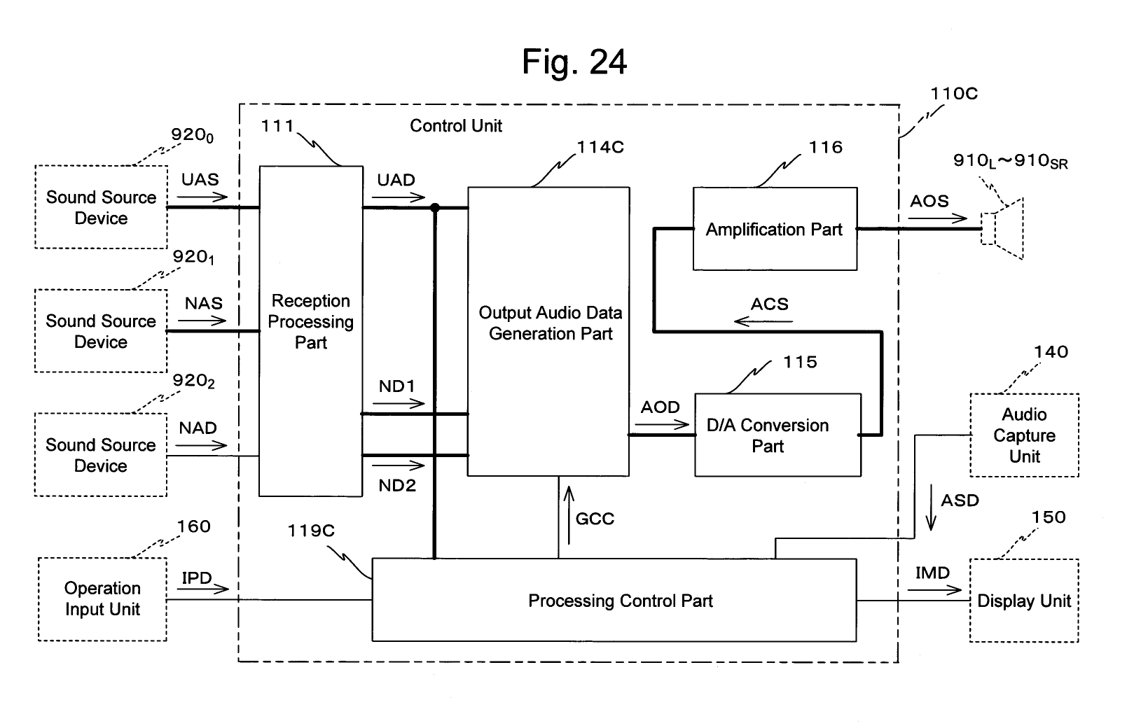

The schematic structure of an acoustic signal processing device 100C according to the third embodiment is shown in FIG. 23. As shown in this FIG. 23, as compared to the acoustic signal processing device 100B of the second embodiment described above (refer to FIG. 15), this acoustic signal processing device 100C only differs by the feature that a control unit 110C is provided, instead of the control unit 110B. As shown in FIG. 24, as compared with the control unit 110B described above (refer to FIG. 16), this control unit 110C only differs by the features that an output audio data generation part 114C is provided, instead of the output audio data generation part 114B, and that a processing control part 119C is provided, instead of the processing control part 119B.

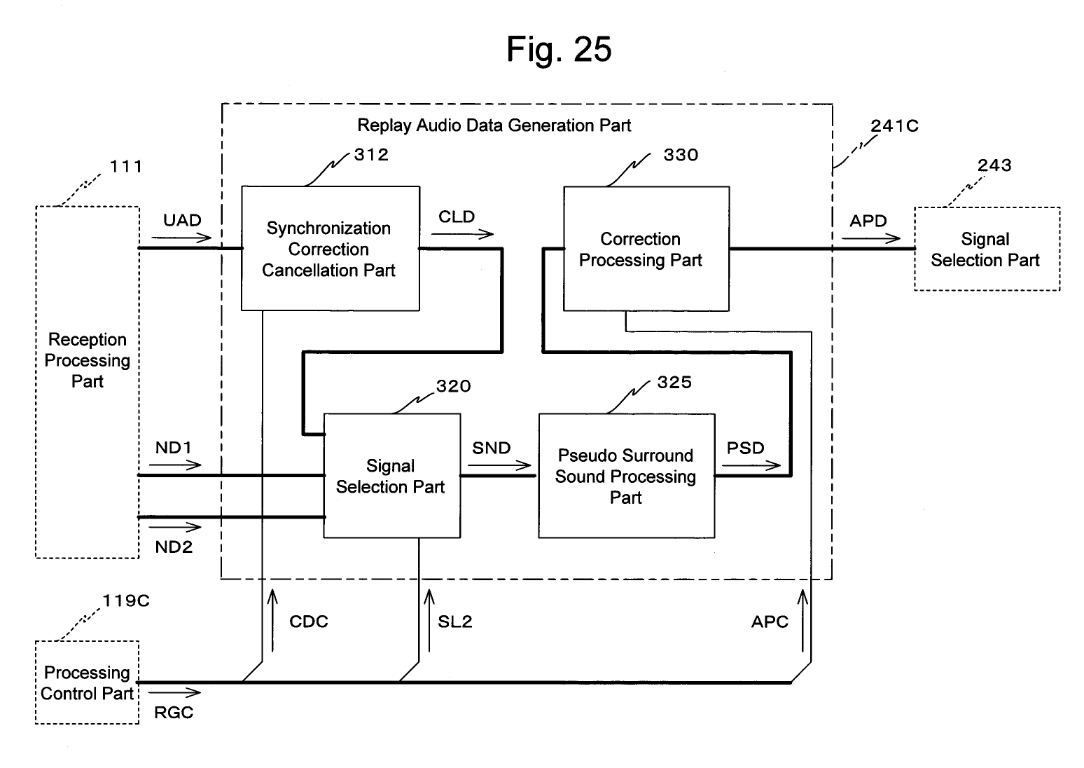

As compared to the output audio data generation part 114B described above, the output audio data generation part 114C mentioned above only differs by the feature that, instead of the replay audio data generation part 241B, a replay audio data generation part 241C having a structure as shown in FIG. 25 is provided. As compared to the replay audio data generation part 241B described above (refer to FIG. 17), this replay audio data generation part 241C only differs by the feature that it further comprises a synchronization correction cancellation part 312 that functions as a synchronization correction cancellation means, and a pseudo surround sound processing part 325 that functions as a pseudo surround sound processing means.

Due to this, as compared with the replay generation command RGB described above, the replay generation command RGC that is supplied from this control processing part 119C to this replay audio data generation part 241C differs by the feature that a synchronization correction cancellation command CDC is additionally included. It should be understood that, as compared with the output generation command GCB described above (refer to FIGS. 16 and 18), the output generation command GCC that is supplied from this control processing part 119C to this output audio data generation part 114C (refer to FIG. 24) differs by the feature that a replay generation command RGC is included, instead of the replay generation command RGB.

The synchronization correction cancellation part 312 described above has a structure similar to that in the case of the first embodiment. In this third embodiment, the synchronization correction cancellation part 312 receives the signal UAD from the reception processing part 111. The synchronization correction cancellation part 312 generates a signal CLD which includes individual signals CLD_{L} through CLD_{SR}, in which the synchronization correction in the specific sound field correction processing has been cancelled, by performing correction by delaying each of the individual signals UAD_{L} through UAD_{SR} in the signal UAD according to a synchronization correction cancellation command CDC in the replay generation command RGC. The signal CLD that has been generated in this manner is sent to the signal selection part 320.

The pseudo surround sound processing part 325 described above receives the signal SND from the signal selection part 320. The pseudo surround sound processing part 325 executes pseudo surround sound processing upon the signal SND in consideration of the mutual correlations between the individual signals SND_{L} through SND_{SR}. The result of this pseudo surround sound processing is sent to the correction processing part 330 as a signal PSD. It should be understood that individual signals PSD_{L} through PSD_{SR} that correspond to the L channel through the SR channel are included in this signal PSD.

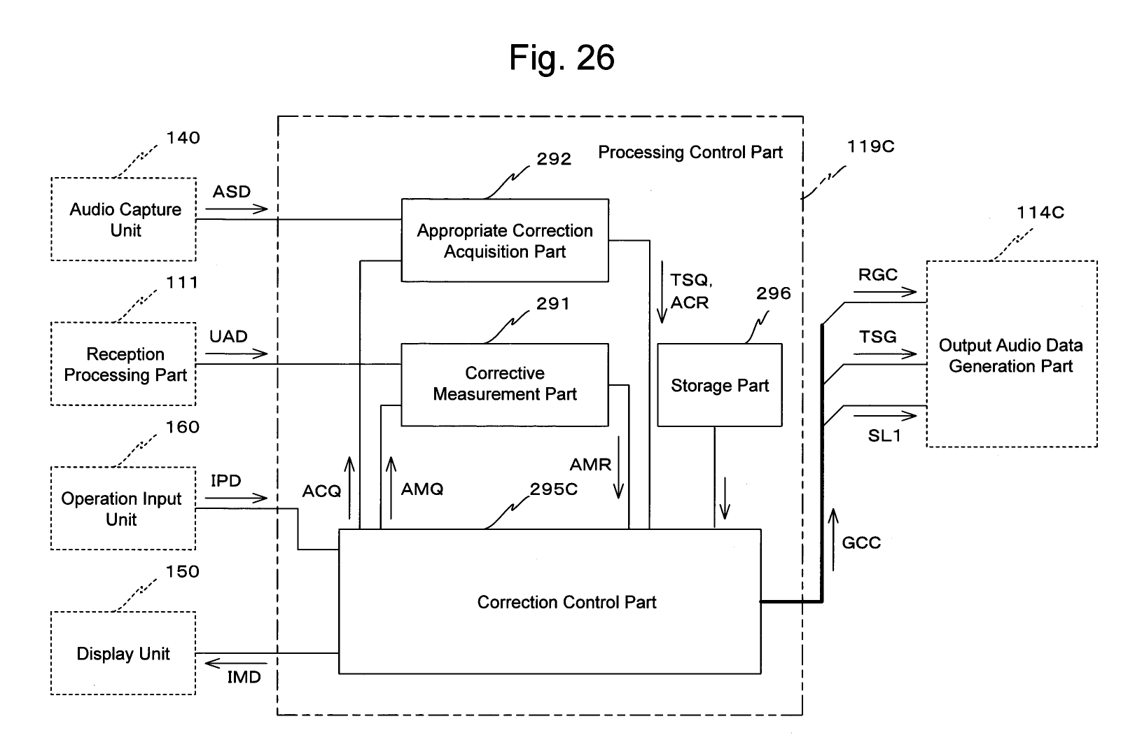

As shown in FIG. 26, as compared to the processing control part 119B described above (refer to FIG. 18), the processing control part 119C described above differs by the feature that it includes a correction control part 295C, instead of the correction control part 295B. This correction control part 295C receives operation input data IPD from the operation input unit 160, and performs control procedures corresponding to this operation input.

When a measurement command for aspects of the sound field correction processing has been inputted by the user with the sound source device 920₀, this correction control part 295C performs processing similar to that of the correction control part 295B.

Furthermore, upon receipt of a corrective measurement result AMR from the corrective measurement part 291 as a result of measurement of individual correction processing, then the correction control part 295C performs similar processing to that of the correction control part 295B. Furthermore, upon receipt of an appropriate correction acquisition result ACR from the appropriate correction acquisition part 292, it performs similar processing to that of the correction control part 295B.

Moreover, when the user inputs to the operation input unit 160 a designation of a type of acoustic signal corresponding to audio to be replay outputted from the speaker units 910_{L} through 910_{SR}, then, on the basis of this acoustic signal designation, the correction control part 295C establishes settings required for audio upon which sound field correction processing has been appropriately carried out to be outputted from the speaker units 910_{L} through 910_{SR}. In these settings, there are included settings for the synchronization correction cancellation part 312 due to the synchronization correction cancellation command CDC, settings for the correction processing part 330 due to the correction control command APC, and settings for the signal selection parts 243 and 320 due to the signal selection commands SL1 and SL2.

For example, when the acoustic signal UAS is designated by the user, first the correction control part 295C reads out the cancellation parameters CNP and the appropriate parameters ADP from the storage part 296. Next, the correction control part 295C generates a synchronization correction cancellation command CDC on the basis of the synchronization correction cancellation parameters in the cancellation parameters CNP, and sends this command to the synchronization correction cancellation part 312.

Furthermore, the correction control part 295C generates a delay correction command ALC on the basis of the synchronization correction parameters in the appropriate parameters ADP. The correction control part 295C calculates differential parameters by adding the frequency characteristic correction parameters and the audio volume correction parameters in the appropriate parameters ADP, and the frequency characteristic correction cancellation parameters and the audio volume correction cancellation parameters in the cancellation parameters CNP. And the correction control part 295C generates a frequency characteristic correction command AFC and an audio volume correction command AVC on the basis of these differential parameters that have been calculated.

The correction control part 295C sends to the correction processing part 330 a correction control command APC that includes the frequency characteristic correction command AFC, the delay correction command ALC, and the audio volume correction command AVC that have been generated in this manner. Subsequently, the correction control part 295C sends a message to the signal selection part 243 to the effect that the signal APD is to be selected as the signal selection command SL1, and also sends a message to the signal selection part 320 to the effect that the signal CLD is to be selected as the signal selection command SL2.

Furthermore, if the acoustic signal NAS or the acoustic signal NAD has been designated by the user, then the correction control part 295C performs similar processing to the case of the correction control part 295B described above.

### <Operation>

Next, the operation of the acoustic signal processing device 100C having the structure as described above will be explained, with attention being principally directed to the processing by the processing control part 119C.

### <<Measurement of Aspects of the Specific Sound Field Correction Processing, and Acquisition of Aspects of the Appropriate Sound Field Correction Processing>>

In this third embodiment, measurement processing for aspects of the specific sound field correction processing is performed in a similar manner to the case of the second embodiment described above (refer to FIG. 20). Furthermore, in this third embodiment, acquisition processing for aspects of the appropriate sound field correction processing is performed in a similar manner to the case of the second embodiment described above (refer to FIG. 21).

### <<Generation of the Replay Audio>>

Next, the processing for generation of the audio to be replay outputted from the speaker units 910_{L} through 910_{SR} will be explained.

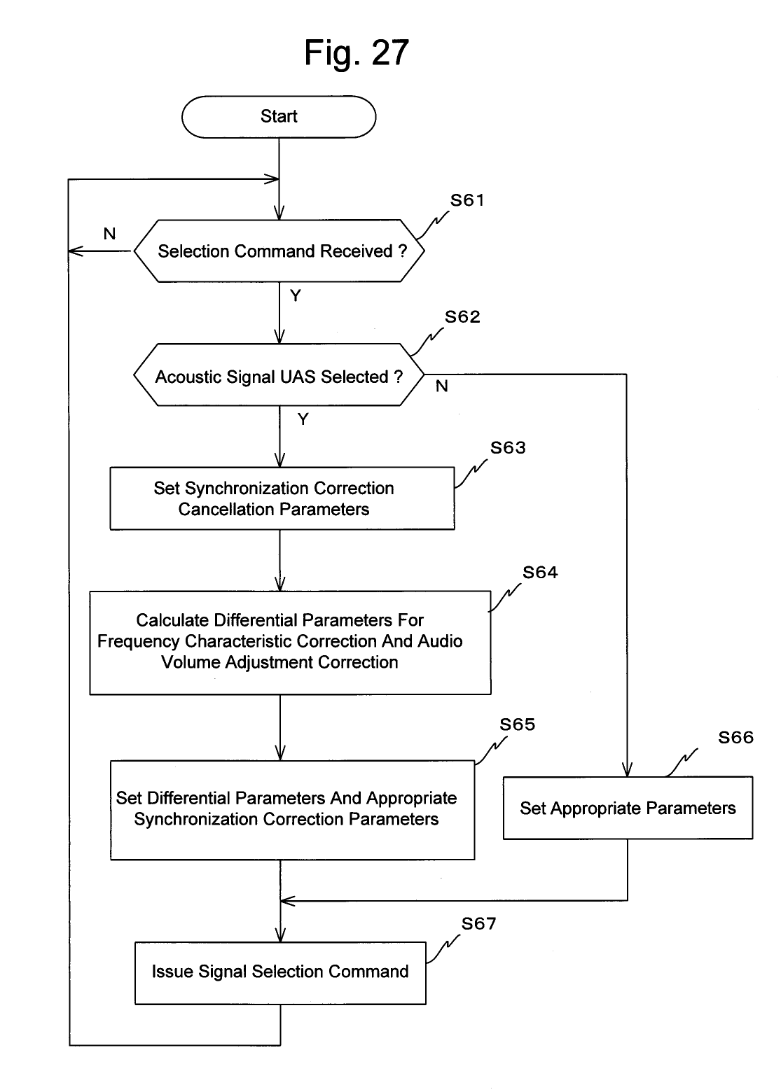

In this processing, as shown in FIG. 27, first in a step S61 the correction control part 295C of the processing control part 119C makes a judgment as to whether or not a replay audio selection command has been received from the operation input unit 160. If the result of this judgment is negative (N in the step S61), then the processing of the step S61 is repeated.

When, in this state, the user utilizes the operation input unit 160 and inputs a selection command for replay audio to the operation input unit 160, a message to this effect is reported to the correction control part 295C as operation input data IPD. Upon receipt of this report, the judgment result in the step S61 becomes affirmative (Y in the step S61), and the flow of control proceeds to a step S62.

In the step S62, the correction control part 295C makes a judgment as to whether or not the replay audio that has been selected is audio that corresponds to the acoustic signal UAS. If the result of this judgment is affirmative (Y in the step S62), the flow of control then proceeds to a step S63. In this step S63, first, the correction control part 295C reads out the cancellation parameters CNP from the storage part 296. Next, the correction control part 295C generates a synchronization correction cancellation command CDC on the basis of the synchronization correction cancellation parameters in the cancellation parameters CNP, and sends it to the synchronization correction cancellation part 312.

Next, in a step S64, first, the correction control part 295C again reads out the appropriate parameters ADP from the storage part 296. Next, the correction control part 295C adds together the frequency characteristic correction parameters and the audio volume correction parameters in the appropriate parameters ADP, and the frequency characteristic correction cancellation parameters and the audio volume correction cancellation parameters in the cancellation parameters CNP, and thereby calculates differential parameters.

Next, in a step S65, first, on the basis of these differential parameters that have been calculated, the correction control part 295C generates a frequency characteristic correction command AFC and an audio volume correction command AVC. Next, the correction control part 295C generates a delay correction command ALC on the basis of the synchronization correction parameters in the appropriate parameters ADP. Then the correction control part 295C sends to the correction processing part 330 a correction control command APC that includes the frequency characteristic correction command AFC, the delay correction command ALC, and the audio volume correction command AVC that have been generated in this manner. Subsequently, the correction control part 295C sends a message to the effect that the signal APD is to be selected to the signal selection part 243 as the signal selection command SL1, and also sends a message to the effect that the signal CLD is to be selected to the signal selection part 320 as the signal selection command SL2.

As a result the signal CLD, in which the synchronization correction processing of the audio volume correction command AVC has been cancelled, and matched to pseudo surround sound processing in which the mutual correlations between the individual signals SND_{L} through SND_{SR} are considered, is supplied to the pseudo surround sound processing part 325 as the signal SND. Furthermore, the correction processing part 330 performs the synchronization correction processing in the appropriate sound field correction processing, and sound field correction processing, which is obtained being subtracted aspects of the frequency characteristic correction processing and the audio volume correction processing in the specific sound field correction processing respectively from those in the appropriate sound field correction processing upon the signal PSD that originates in the signal CLD.

On the other hand, if the result of the judgment in the step S62 is negative (N in the step S62), then the flow of control proceeds to a step S66. In this step S66, first, the correction control part 295C reads out the appropriate parameters ADP from the storage part 296. And, on the basis of these appropriate parameters, the correction control part 295B generates a correction control command APC including a frequency characteristic correction command AFC, a delay correction command ALC, and an audio volume correction command AVC, that are required for performing sound field correction processing in an appropriate manner. And the correction control part 295C sends this correction control command APC that has been generated to the correction processing part 330. As a result, appropriate sound field correction processing comes to be carried out by the correction processing part 330.

As explained above, when the setting of the correction processing part 330 ends, in a step S67, the correction control part 295C sends to the signal selection parts 243 and 320 the signal selection commands SL1 and SL2 that are required for audio based upon the designated acoustic signal to be outputted from the speaker units 910_{L} through 910_{SR}.

Here, if the acoustic signal UAS has been designated, then the correction control part 295C sends to the signal selection part 243, as the signal selection command SL1, a message to the effect that the signal APD is to be selected, and also sends to the signal selection part 320, as the signal selection command SL2, a message to the effect that the signal CLD is to be selected. As a result, output acoustic signals AOS_{L} through AOS_{SR} in a state in which appropriate sound field correction processing has been carried out upon the original acoustic signal, which is the acoustic signal UAS, are supplied to the speaker units 910_{L} through 910_{SL}.

Furthermore, if the acoustic signal NAS has been designated, then the correction control part 295C sends to the signal selection part 243, as the signal selection command SL1, a message to the effect that the signal APD is to be selected, and also sends to the signal selection part 320, as the signal selection command SL2, a message to the effect that the signal ND1 is to be selected. As a result, output acoustic signals AOS_{L} through AOS_{SR} in a state in which appropriate sound field correction processing has been carried out upon the acoustic signal NAS are supplied to the speaker units 910_{L} through 910_{SL}.

Furthermore, if the acoustic signal NAD has been designated, then the correction control part 295C sends to the signal selection part 243, as the signal selection command SL1, a message to the effect that the signal APD is to be selected, and also sends to the signal selection part 320, as the signal selection command SL2, a message to the effect that the signal ND2 is to be selected. As a result, output acoustic signals AOS_{L} through AOS_{SR} in a state in which appropriate sound field correction processing has been carried out upon the acoustic signal NAD are supplied to the speaker units 910_{L} through 910_{SL}.

As has been explained above, with this third embodiment, the corrective measurement part 291 of the processing control part 119C measures aspects of the specific sound correction processing that is carried out upon the acoustic signal UAS received from the sound source device 920₀, which is a specific external device. Furthermore, the appropriate correction acquisition part 292 of the processing control part 119C acquires aspects of the appropriate sound field correction processing that correspond to the actual sound field space ASP.

And, if it has been selected to perform replay output of audio corresponding to the acoustic signal UAS upon which the specific sound field correction processing is being performed, then the synchronization correction processing in the specific sound field correction processing is cancelled by the synchronization correction cancellation part 312. Due to this, pseudo surround sound processing is performed, in a state in which the individual signals in the original acoustic signal are mutually synchronized to one another.

Moreover, if it has been selected to perform replay output of audio corresponding to the acoustic signal UAS upon which the specific sound field correction processing is being performed, then settings are made upon the correction processing part 330 to perform sound field correction processing in which the frequency characteristic correction processing aspects and the audio volume correction processing aspects in the specific sound field correction processing are subtracted from the frequency characteristic correction processing aspects and the audio volume correction processing aspects in the appropriate sound field correction processing, and the synchronization correction processing in the appropriate sound field correction processing.

Furthermore, if it has been selected to perform replay output of audio corresponding to the acoustic signal NAS or the acoustic signal NAD upon which no sound field correction processing has been performed, then pseudo surround sound processing is performed upon the signal ND1 or the signal ND2 that corresponds to that acoustic signal NAS or acoustic signal NAD. And settings are performed upon the correction processing part 330 to perform the appropriate sound field correction processing.

Accordingly, whichever of the acoustic signals UAS, NAS, and NAD may be selected, it is possible to supply output acoustic signals AOS_{L} through AOS_{SR} to the speaker units 910_{L} through 910_{SR} in a state in which appropriate pseudo surround sound processing and sound field correction processing have been carried out thereupon.

Furthermore, in this third embodiment, in a similar manner to the case with the first embodiment and with the second embodiment, when measuring aspects of synchronization correction processing included in the sound field correction processing by the sound source device 920₀, sounds in pulse form generated simultaneously at the period T_{P} and corresponding to the L channel through the SR channel are used as the audio contents for measurement. Due to this, in a similar manner to the case with the first embodiment and with the second embodiment, by the corrective measurement part 291 analyzing change of the signal UAD after the no-signal interval of the signal UAD has continued for at least the time period T_{P}/2, it is possible correctly to measure aspects of synchronization correction processing by the sound source device 920₀.

### Modification of the Embodiment

The present invention is not to be considered as being limited to the first through the third embodiments described above; alterations of various types are possible.

For example, the types of individual sound field correction in the first through third embodiments described above are given by way of example; it would also be possible to reduce the types of individual sound field correction, or alternatively to increase them with other types of individual sound field correction.

Furthermore while, in the first through third embodiments described above, pink noise sound was used during measurement for the frequency characteristic correction processing aspects and during measurement for the audio volume balance correction processing aspects, it would also be acceptable to arrange to use white noise sound.

Yet further, during measurement for the synchronization correction processing aspects, it would be possible to employ half sine waves, impulse waves, triangular waves, sawtooth waves, spot sine waves or the like.

Moreover while, in the first through third embodiments described above, it was arranged for the user to designate the type of individual sound field correction that was to be the subject of measurement for each of the aspects of individual sound field correction processing, it would also be acceptable to arrange to perform the measurements for the three types of aspects of individual sound field processing in a predetermined sequence automatically, by establishing synchronization between the generation of the acoustic signal UAS for measurement by the sound source device 920₀, and measurement processing by the acoustic signal processing devices 100A, 100B, and 100C.

Even further, the format of the acoustic signals in the first through third embodiments described above is only given by way of example; it would also be possible to apply the present invention even if the acoustic signals are received in a different format. Furthermore, the number of acoustic signals for which sound field correction is not performed may be any desired number.

Yet further while, in the first through third embodiments described above, it was arranged to employ the four channel surround sound format and to provide four speaker parts, it would also be possible to apply the present invention to an acoustic signal processing device which separates or mixes together acoustic signals resulting from reading out audio contents, as appropriate, and which causes the resulting audio to be outputted from two speakers or from three speakers, or from five or more speakers.

It would also be possible to implement changes to the second embodiment described above, that are similar to the changes made to the third embodiment; and it would also be possible to implement such changes to the first embodiment.

Yet further while, in the third embodiment described above, it was supposed that the pseudo surround sound processing performed by the pseudo surround sound processing part 325 was of a single type, it would also be acceptable to arrange to perform, on the basis of control by the processing control part, from among a plurality of types of pseudo surround sound processing, pseudo surround sound processing as designated by the user. In this case, it would also be acceptable for pseudo-surround sound processing in which no consideration is given to correlation between the individual signals to be included in this plurality of types of pseudo surround sound processing.

It should be understood that it would also be possible to arrange to implement the control part of any of the embodiments described above as a computer system that comprises a central processing device (CPU: Central Processing Part) or a DSP (Digital Signal Processor), and to arrange to implement the functions of the above control part by execution of one or more programs. It would be acceptable to arrange for these programs to be acquired in the format of being recorded upon a transportable recording medium such as a CD-ROM, a DVD, or the like; or it would also be acceptable to arrange for them to be acquired in the format of being transmitted via a network such as the internet or the like.

1-15. (canceled)

16. An acoustic signal processing device that creates acoustic signals to be supplied to a plurality of speakers, each of which outputs sound according to a channel assigned previously to a sound field space, comprising:
a reception part configures to receive acoustic signals from each of a plurality of external devices;
a measurement part configures to measure an aspect of specific sound field correction processing, which is sound field correction processing carried out upon a specific acoustic signal, which is an acoustic signal received from a specific one among said plurality of external devices;
an acquisition part configures to acquires an aspect of appropriate correction processing, which is sound field correction processing corresponding to said sound field space that is to be carried out upon an original acoustic signal; and
a generation part configures to generate an acoustic signal by carrying out said appropriate correction processing upon the original acoustic signal that corresponds to said specific acoustic signal, on the basis of the result of measurement by said measurement part and the result of acquisition by said acquisition part, when said specific acoustic signal has been selected as the acoustic signal to be supplied to said plurality of speakers, wherein
said specific sound field correction processing for a subject by said measurement part is at least one of individual sound field correction processing selected from the group consisting of synchronization correction processing that aims to improve the synchronization of audio outputted from each of said plurality of speakers, audio volume balance correction processing in which the balances of the volumes of audio outputted from each of said plurality of speakers are corrected, and frequency characteristic correction processing in which the frequency characteristics of acoustic signals supplied to each of said plurality of speakers are corrected.

17. An acoustic signal processing device according to claim 16, wherein
said measurement part configures to measure said aspect of said specific sound field correction processing by analyzing said specific acoustic signal that said specific external device has generated from audio contents for measurement.

18. An acoustic signal processing device according to claim 16, wherein
in said sound field correction processing, there is included synchronization correction processing that aims to improve the synchronization of audio outputted from each of said plurality of speakers;
when measuring aspects of synchronization correction processing included in said specific sound field correction processing with said measurement part, as original individual acoustic signals corresponding to each of said plurality of speakers in the original acoustic signal that corresponds to said specific acoustic signal, signals in pulse form are used that are generated simultaneously at a period that is more than twice as long as the maximum mutual delay time period difference between the delay time periods imparted to each of said original individual acoustic signals by said synchronization correction processing; and
said measurement part measures said aspects of said synchronization correction processing on the basis of said specific acoustic signal, after a period of ½ of said period has elapsed from the time point that a signal in pulse form has been initially detected in any one of the individual acoustic signals in acoustic signal from said specific external device.

19. An acoustic signal processing device according to claim 16, further comprising:
an audio capture part configures to capture audio at an audio capture position within said sound field space; and in that said acquisition part calculates said aspects of said appropriate correction processing, on the basis of the result from said audio capture part when test audio is outputted from each of said plurality of speakers.

20. An acoustic signal processing device according to claim 16, wherein
said generation part comprises:
a cancellation part configures to cancel sound field correction processing carried out upon said specific acoustic signal, on the basis of the results of measurement by said measurement part; and
a correction part configures to carry out said appropriate correction processing upon the result of cancellation by said cancellation part, when said specific acoustic signal has been selected as the acoustic signal to be supplied to said plurality of speakers.

21. An acoustic signal processing device according to claim 20, wherein
an acoustic signal received from an external device other than said specific external device is a non-corrected acoustic signal for which it is already known that sound field correction processing has not been carried out; and
when said non-corrected acoustic signal has been selected as the acoustic signal to be supplied to said plurality of speakers, said non-corrected acoustic signal is supplied to said correction part, and said correction part carries out said appropriate correction processing upon said non-corrected acoustic signal.

22. An acoustic signal processing device according to claim 16, wherein said part comprises a correction part configures to carry out sound field correction processing that corresponds to the differential between said appropriate correction processing and said specific correction processing upon said specific acoustic signal, when said specific acoustic signal has been selected as the acoustic signal to be supplied to said plurality of speakers.

23. An acoustic signal processing device according to claim 22, wherein
an acoustic signal received from an external device other than said specific external device is a non-corrected acoustic signal for which it is already known that sound field correction processing has not been carried out; and
when said non-corrected acoustic signal has been selected as the acoustic signal to be supplied to said plurality of speakers, said correction part carries out said appropriate connection processing upon said non-corrected acoustic signal.

24. An acoustic signal processing device according to claim 16, wherein
in said sound field correction processing, there is included synchronization correction processing that aims to improve the synchronization of audio outputted from each of said plurality of speakers; and
said generation part comprises:
a synchronization correction cancellation part configures to cancel synchronization correction processing included in said specific correction processing, on the basis of the result of measurement by said measurement part;
a pseudo surround sound processing part configures to carry out predetermined pseudo surround sound processing upon the result of cancellation by said synchronization correction cancellation part, when said specific acoustic signal has been selected as the acoustic signal to be supplied to said plurality of speakers; and
a correction part configures to also carry out synchronization correction processing included in said appropriate correction processing upon the result of processing by said pseudo surround sound processing part, along with carrying out correction processing that corresponds to the differential between correction processing other than synchronization correction processing included in said appropriate correction processing and correction processing other than synchronization correction processing included in said specific correction processing upon the result of processing by said pseudo surround sound processing part.

25. An acoustic signal processing device according to claim 24, wherein
an acoustic signal received from an external device other than said specific external device is a non-corrected acoustic signal for which it is already known that sound field correction processing has not been carried out;
when said non-corrected acoustic signal has been selected as the acoustic signal to be supplied to said plurality of speakers, said non-corrected acoustic signal is supplied to said pseudo surround sound processing part; and
said correction part carries out said appropriate correction processing upon the result of processing by said pseudo surround sound processing part.

26. An acoustic signal processing device according to claim 16, wherein
in said sound field correction processing, there is included at least one of audio volume balance correction processing in which the balances of the volumes of audio outputted from each of said plurality of speakers are corrected, and frequency characteristic correction processing in which the frequency characteristics of acoustic signals supplied to each of said plurality of speakers are corrected.

27. An acoustic signal processing device according to claim 16, wherein
said acoustic signal processing device is mounted to a mobile body.

28. An acoustic signal processing method that creates acoustic signals to be supplied to a plurality of speakers, each of which outputs sound according to a channel assigned previously to a sound field space, comprising the steps of:
measuring an aspect of specific sound field correction processing, which is sound field correction processing carried out upon a specific acoustic signal, which is an acoustic signal received from a specific one among a plurality of external devices;
acquiring an aspect of appropriate correction processing, which is sound field correction processing corresponding to said sound field space that is to be carried out upon an original acoustic signal; and
generating an acoustic signal by carrying out said appropriate correction processing upon the original acoustic signal that corresponds to said specific acoustic signal, on the basis of the result of measurement by said measurement process and the result of acquisition by said acquisition process, wherein
said specific sound field correction processing to be a subject in said measuring step is at least one of individual sound field correction processing selected from the group consisting of a synchronization correction processing for synchronizing the individual sound output from said plurality of speakers, sound volume balance correction processing for correcting a balance of a sound volume output from said plurality of speakers, and a frequency characteristic correction processing for correcting the frequency characteristic of the individual acoustic signals in the original acoustic signal supplied to said plurality of speakers.

29. An acoustic signal processing program, causing a calculation part to carry out an acoustic signal processing method according to claim 28.

30. A recording medium, an acoustic signal processing program according to claim 29, being recorded thereupon in a manner that is readable by a calculation part.

31. An acoustic signal processing device according to claim 17, wherein
in said sound field correction processing, there is included synchronization correction processing that aims to improve the synchronization of audio outputted from each of said plurality of speakers;
when measuring aspects of synchronization correction processing included in said specific sound field correction processing with said measurement part, as original individual acoustic signals corresponding to each of said plurality of speakers in the original acoustic signal that corresponds to said specific acoustic signal, signals in pulse form are used that are generated simultaneously at a period that is more than twice as long as the maximum mutual delay time period difference between the delay time periods imparted to each of said original individual acoustic signals by said synchronization correction processing; and
said measurement part measures said aspects of said synchronization correction processing on the basis of said specific acoustic signal, after a period of ½ of said period has elapsed from the time point that a signal in pulse form has been initially detected in any one of the individual acoustic signals in acoustic signal from said specific external device.
